(19) United States
(12) Patent Application Publication
(10) Pub. No.: US 2026/0046889 A1
(43) Pub. Date: Feb. 12, 2026

(54) DATA INDICATOR FIELD FORMAT FOR DOWNLINK CONTROL INFORMATION

(71) Applicant: QUALCOMM Incorporated, San Diego, CA (US)

(72) Inventors: Mostafa KHOSHNEVISAN, San Diego, CA (US); Jing SUN, San Diego, CA (US); Gabi SARKIS, San Diego, CA (US)

(21) Appl. No.: 18/800,899

(22) Filed: Aug. 12, 2024

(51) Int. Cl. H04W 72/231; H04L 1/00; H04L 1/08; H04L 1/1812

(52) U.S. Cl. CPC H04W 72/231; H04L 1/0027; H04L 1/08; H04L 1/1812

(57) ABSTRACT

Various aspects of the present disclosure generally relate to wireless communication. In some aspects, a user equipment (UE) may obtain configuration information indicating one or more new data indicator (NDI) field formats for respective downlink control information (DCI) formats. The UE may receive a first DCI communication associated with a first DCI format associated with a first NDI field format, of the one or more NDI field formats, as indicated by the configuration information. Numerous other aspects are described.

### FIELD OF THE DISCLOSURE

Aspects of the present disclosure generally relate to wireless communication and specifically relate to techniques, apparatuses, and methods for new data indicator field formats for downlink control information.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a user equipment (UE) for wireless communication. The user equipment may include one or more memories and one or more processors coupled to the one or more memories. The one or more processors may be configured to obtain configuration information indicating one or more new data indicator (NDI) field formats for respective downlink control information (DCI) formats. The one or more processors may be configured to receive a first DCI communication associated with a first DCI format associated with a first NDI field format, of the one or more NDI field formats, as indicated by the configuration information.

Some aspects described herein relate to a network node for wireless communication. The network node may include one or more memories and one or more processors coupled to the one or more memories. The one or more processors may be configured to transmit configuration information indicating one or more NDI field formats for respective DCI formats. The one or more processors may be configured to transmit a first DCI communication associated with a first DCI format in accordance with a first NDI field format, of the one or more NDI field formats, associated with the first DCI format.

Some aspects described herein relate to a method of wireless communication performed by a UE. The method may include obtaining configuration information indicating one or more NDI field formats for respective DCI formats. The method may include receiving a first DCI communication associated with a first DCI format associated with a first NDI field format, of the one or more NDI field formats, as indicated by the configuration information.

Some aspects described herein relate to a method of wireless communication performed by a network node. The method may include transmitting configuration information indicating one or more NDI field formats for respective DCI formats. The method may include transmitting a first DCI communication associated with a first DCI format in accordance with a first NDI field format, of the one or more NDI field formats, associated with the first DCI format.

Some aspects described herein relate to a non-transitory computer-readable medium that stores a set of instructions for wireless communication by an UE. The set of instructions, when executed by one or more processors of the UE, may cause the UE to obtain configuration information indicating one or more NDI field formats for respective DCI formats. The set of instructions, when executed by one or more processors of the UE, may cause the UE to receive a first DCI communication associated with a first DCI format associated with a first NDI field format, of the one or more NDI field formats, as indicated by the configuration information.

Some aspects described herein relate to a non-transitory computer-readable medium that stores a set of instructions for wireless communication by a network node. The set of instructions, when executed by one or more processors of the network node, may cause the network node to transmit configuration information indicating one or more NDI field formats for respective DCI formats. The set of instructions, when executed by one or more processors of the network node, may cause the network node to transmit a first DCI communication associated with a first DCI format in accordance with a first NDI field format, of the one or more NDI field formats, associated with the first DCI format.

Some aspects described herein relate to an apparatus for wireless communication. The apparatus may include means for obtaining configuration information indicating one or more NDI field formats for respective DCI formats. The apparatus may include means for receiving a first DCI communication associated with a first DCI format associated with a first NDI field format, of the one or more NDI field formats, as indicated by the configuration information.

Some aspects described herein relate to an apparatus for wireless communication. The apparatus may include means for transmitting configuration information indicating one or more NDI field formats for respective DCI formats. The apparatus may include means for transmitting a first DCI communication associated with a first DCI format in accordance with a first NDI field format, of the one or more NDI field formats, associated with the first DCI format.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 is a diagram illustrating an examples of signaling exchanged between a transmitting device and a receiving device, in accordance with the present disclosure.

FIG. 5 is a diagram of an example associated with signaling for new data indicator (NDI) field formats for downlink control information (DCI), in accordance with the present disclosure.

FIG. 6 is a diagram of examples associated with new data identifications for different NDI field formats, in accordance with the present disclosure.

FIG. 7 is a diagram of examples associated with a stored or maintained NDI value, in accordance with the present disclosure.

FIG. 8 is a diagram illustrating an example process performed, for example, at a UE or an apparatus of a UE, in accordance with the present disclosure.

FIG. 9 is a diagram illustrating an example process performed, for example, at a network node or an apparatus of a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Some wireless networks use a hybrid automatic repeat request (HARQ) process to improve reliability of data transmissions by combining forward error correction (FEC) with the automatic repeat request (ARQ) retransmission. HARQ facilitates retransmissions with incremental redundancy (e.g., sending additional data instead of retransmitting the entire message).

For downlink or uplink scheduling associated with a given HARQ process, when a new transport block (TB) is to be scheduled for the same HARQ process ID (as opposed to HARQ retransmissions of the previous TB), a user equipment (UE) receives the new data without soft combining. The new data is tagged with or indicated via a new data indicator (NDI). When the NDI value (as indicated by the downlink control information (DCI) scheduling the new data) is toggled, the NDI indicates that a new transport block is scheduled. Hence, the UE does not soft combine the new transport block with previously received transport block(s) associated with the same HARQ process ID (or may not transmit a retransmission of a previously scheduled transport block in an uplink example). When the NDI value is not toggled (e.g., when two DCI associated with the same HARQ process ID indicate the same NDI value), the UE may perform soft combining or may transmit a retransmission as the scheduled transport block is a HARQ retransmission.

For example, a first DCI may schedule the transmission of a first transport block, and may indicate that the first transport block is associated with a given HARQ process ID and a first NDI. The first NDI may be associated with a first value (e.g., a single bit value). Later, the network node may transmit a second DCI to schedule a second (e.g., different) transport block, and may indicate that the second transport block is associated with the same HARQ identifier and a second NDI (e.g., the second NDI may have a different value than the first NDI to indicate that a new transport block (e.g., the second transport block) is being scheduled for the given HARQ process ID). However, the UE may not successfully detect, receive, or decode the second DCI and/or subsequent DCI scheduling the second transport block. After transmitting the second DCI, the network node may transmit a third DCI to schedule a third (e.g., different) transport block, and may indicate that the third transport block is associated with the same HARQ identifier and a third NDI (e.g., the third NDI may have a different value than the second NDI to indicate that a new transport block (e.g., the third transport block) is being communicated for the given HARQ process ID).

However, in examples where an NDI field includes a single bit, the first NDI associated with the first transport block may have the same value as the third NDI associated with the third transport block. For example, the first NDI may have a bit value of one (1). The network node may toggle the NDI for the second NDI to a value of zero (0) to indicate a new transport block (e.g., the second transport block 410-b) is being scheduled for the given HARQ process ID. Later, the network node may toggle the NDI for the third NDI to a value of one (1) to indicate a new transport block (e.g., the third transport block) is being scheduled for the given HARQ process ID.

In such examples, the UE may incorrectly identify that the first transport block and the third transport block are the same transport block. For example, the UE may incorrectly identify that the third DCI is scheduling a retransmission of the first transport block because the third NDI has the same value as the first NDI. Because the UE identifies that the first transport block and the third transport block are the same transport block, the UE may incorrectly perform one or more HARQ operations for the third transport block.

For example, in downlink scenarios, if the UE already successfully decoded the first transport block (e.g., and transmitted a HARQ acknowledgement (ACK) communication), then the UE may incorrectly discard or ignore the third transport block because the UE identifies that is has already successfully decoded the first transport block (e.g., resulting in the third transport block being lost). As another example, if the UE has not successfully decoded the first transport block (e.g., and transmitted a HARQ negative ACK (NACK) communication), then the UE may attempt to combine (e.g., via soft combining or incremental redundancy combining) the first transport block and the third transport block. Because the first transport block and the third transport block are actually different transport blocks, this may result in one or more decoding errors and consume processing resource associated with the UE attempting to combine different transport blocks. In uplink scenarios, the UE may incorrectly transmit a retransmission of the first transport block rather than transmitting the third (e.g., different) transport block using the uplink resources allocated or granted via the third DCI. This may consume network resources and/or processing resources associated with the UE transmitting, and the network node receiving, the retransmission of the first transport block rather than transmitting the third (e.g., different) transport block. In sum, the UE incorrectly performing the one or more HARQ operations for the third transport block may consume network resources, processing resources, and/or power resources associated with the UE performing the one or more HARQ operations. In some examples, the UE incorrectly performing the one or more HARQ operations for the third transport block may result in the transport block being lost and/or increase latency associated with communicating the transport block, among other examples.

In some examples, to address the problems associated with a single bit NDI field, a size of the NDI field (e.g., an NDI bit-width) may be increased, such as to two bits (e.g., resulting in four possible values being indicated by the NDI field rather than only two possible values). In such examples, the first NDI may have a first value (e.g., a bit value of “00”), the second NDI may have a second value (e.g., a bit value of “01”), and the third NDI may have a third value (e.g., a bit value of “10”). Because the first NDI and the third NDI have different values, the UE may correctly identify that the first DCI and the third DCI are scheduling different transport blocks. Therefore, increasing the size of the NDI field reduces the likelihood of the UE incorrectly identifying that DCIs are scheduling the same transport block. Further, increasing the size of the NDI field enables the UE to identify when a DCI has been missed or not received by the UE. For example, when a value of the NDI for a given HARQ identifier (e.g., the HARQ identifier 415) increases by more than a single step (e.g., modulo 4 in the example of a two-bit NDI field, such as from a bit value of “00” to a bit value of “10” in the example described above), the UE may identify that the DCI is scheduling a new transport block and that one or more transport blocks or DCI have been missed by the UE (e.g., because the UE expects the network node to change the NDI value by a single step for each new transport block associated with the HARQ identifier). This enables the UE to indicate to the network node that the one or more transport blocks or DCI have been missed by the UE, thereby enabling the network node to perform one or more actions to schedule and/or communicate the missed transport block(s).

However, increasing the size of the NDI field increases the size of the DCI payload. This increases signaling overhead associated with scheduling communications for the UE. The larger size NDI field may not be as useful in certain scenarios, which may result in unnecessarily increasing the signaling overhead associated with scheduling communications in those scenarios. For example, in uplink scenarios, the network node can identify that a scheduling DCI is missed by the UE based on uplink demodulation reference signal (DMRS) detection by the network node. Further, some DCI formats may not be configurable by the network node, such as DCI format 1_0 and/or DCI format 0_0. Therefore, increasing the size of the NDI field result in increased signaling overhead even in scenarios where the larger size NDI field may not be as useful or may not be needed.

Various aspects relate generally to NDI field formats for control information, such as DCI. Some aspects more specifically relate to processes and/or operations to enable different DCI formats to have different NDI field formats (e.g., to have NDI fields having different sizes or different bit-widths). In some aspects, an NDI field format (or NDI field size) for a given DCI format may be configurable (e.g., by a network node). For example, a network node may transmit, and a UE may receive, configuration information indicating an NDI field format (e.g., an NDI field size) for a given DCI format (e.g., and for a given component carrier (CC)). In some aspects, DCI formats associated with scheduling uplink communications have a first NDI field format (e.g., NDI fields having a first size) and DCI formats associated with scheduling downlink communications have a second NDI field format (e.g., NDI fields having a second size).

In some aspects, there may one or more restrictions associated with scheduling communications (e.g., scheduling transport blocks) for a given HARQ process ID when different DCI formats have different NDI field formats. For example, the network node may refrain from using DCI formats having different NDI field formats (e.g., different NDI field sizes) for the same HARQ process ID (e.g., the network node may only use DCI formats having the same NDI field size for a given HARQ process ID). In some other aspects, the network node may refrain from using DCI formats having different NDI field formats when scheduling a retransmission of a given communication (e.g., a given transport block). For example, DCI formats having different NDI field formats may be used to schedule communications for a given HARQ process ID, but only for scheduling new transmissions or new transport blocks. For example, if an initial transmission is scheduled using a DCI format having a given NDI field format (e.g., an NDI field size of X bits), then the network node may schedule any retransmissions of the initial transmission using DCI format(s) having the given NDI field format (e.g., having an NDI field size of X bits).

In some other aspects, DCI formats having different NDI field formats may be used to schedule new transmissions or retransmissions for a given HARQ process ID without restrictions. In such examples, the UE may receive a first DCI having an NDI field size of M bits associated with a given HARQ process ID and may later receive a second DCI having an NDI field size of N bits associated with the given HARQ process ID. The UE may use certain bit(s) (for example, one or more least significant bits (LSBs) or one or more most significant bits (MSBs)) from the larger NDI field size to identify whether the second DCI is scheduling a new transmission or a retransmission. As another example, the UE may maintain or store an NDI value having a size (e.g., a quantity of bits) that is a largest possible NDI field size for different DCI formats. If a received DCI has an NDI field size equal to the size of the NDI value, then the UE may update the NDI value to the value indicated by the NDI of the received DCI. If a received DCI has an NDI field size smaller than the size of the NDI value, then the UE may compare certain bit(s) (for example, one or more least significant bits (LSBs) or one or more most significant bits (MSBs)) from the NDI value to the NDI indicated in the received DCI to determine whether to change or update the NDI value. The UE may use the maintained or stored NDI value to determine whether a DCI is scheduling a new transmission or a retransmission.

Particular aspects of the subject matter described in this disclosure can be implemented to realize one or more of the following potential advantages. In some examples, by the network node and/or the UE performing one or more operations to enable different DCI formats to have different NDI field formats (e.g., different NDI field sizes), the described techniques can be used to improve HARQ operations with improved flexibility. The improved HARQ operations may improve the reliability and/or decrease latency of communications between the UE and the network node. The improved flexibility may enable the network node to transmit DCI having a smaller payload size (e.g., a smaller NDI field size) in some scenarios, thereby conserving network resources that would have otherwise been associated with transmitting DCI having a larger payload size (e.g., a larger NDI field size). For example, by the network node configuring a size of an NDI field for a given DCI format, a size of the NDI field may be tailored or customized to a given scenario or situation. This enables larger NDI field sizes to be used to improve HARQ operations in some scenarios and smaller NDI field sizes to be used to reduce DCI payload size in other scenarios for the same DCI format.

In some aspects, by the network node and the UE operating in accordance with the one or more restrictions for NDI field formats for a given HARQ process ID, the likelihood that the UE is able to correctly identify whether a DCI is scheduling a new transmission or a retransmission may be improved. In some aspects, by the UE comparing certain defined bits (e.g., one or more LSBs or one or more MSBs) from larger NDI fields to bits in a smaller NDI fields, the likelihood that the UE is able to correctly identify whether a DCI is scheduling a new transmission or a retransmission may be improved. In some aspects, by the UE storing and/or maintaining an NDI value and updating the NDI value based on, or otherwise associated with, values of NDIs in received DCI, the UE may be enabled to identify whether a DCI is scheduling a new transmission or a retransmission using the stored or maintained NDI value. This improves the likelihood that the UE is able to correctly identify whether a DCI is scheduling a new transmission or a retransmission. Further, the UE may use the stored or maintained NDI value to obtain additional information associated with a given HARQ process ID, such as whether one or more DCI or scheduled communications (e.g., scheduled transport blocks) were missed by the UE.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

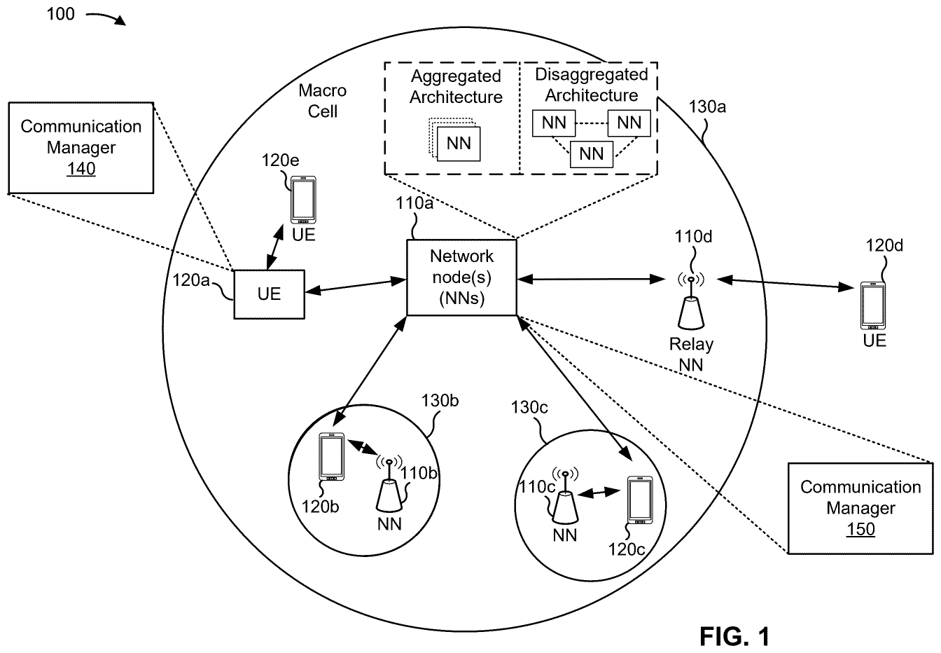

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit DCI (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network. ” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may obtain configuration information indicating one or more NDI field formats for respective DCI formats; and receive a first DCI communication associated with a first DCI format associated with a first NDI field format, of the one or more NDI field formats, as indicated by the configuration information. Additionally, or alternatively, the communication manager 140 may perform one or more other operations described herein.

In some aspects, the network node 110 may include a communication manager 150. As described in more detail elsewhere herein, the communication manager 150 may transmit configuration information indicating one or more NDI field formats for respective DCI formats; and transmit a first DCI communication associated with a first DCI format in accordance with a first NDI field format, of the one or more NDI field formats, associated with the first DCI format. Additionally, or alternatively, the communication manager 150 may perform one or more other operations described herein.

As indicated above, FIG. 1 is provided as an example. Other examples may differ from what is described with regard to FIG. 1.

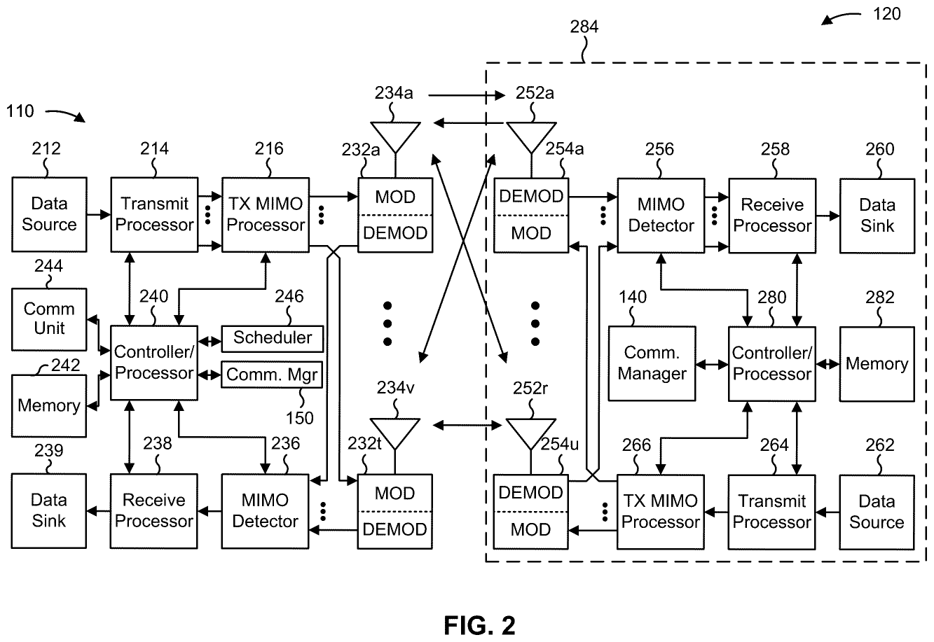

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors.

Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a DMRS, or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more TBs of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples.

The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

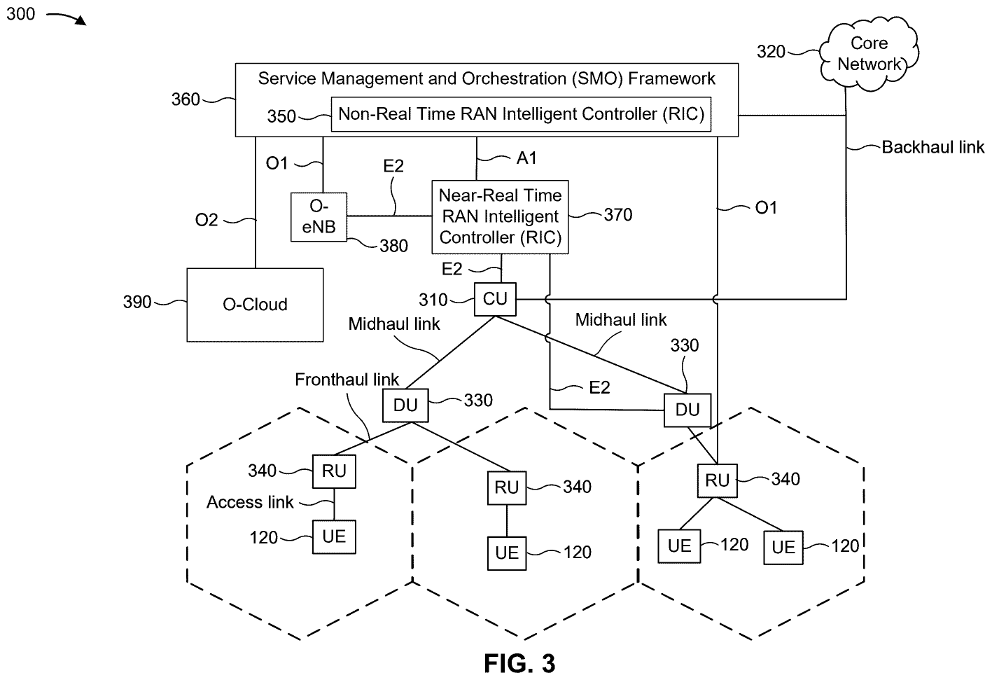

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

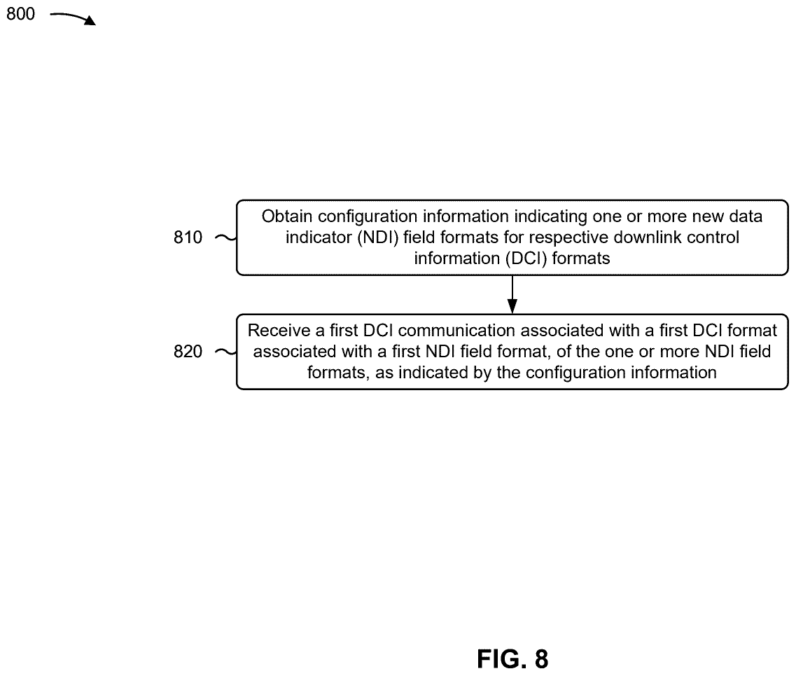

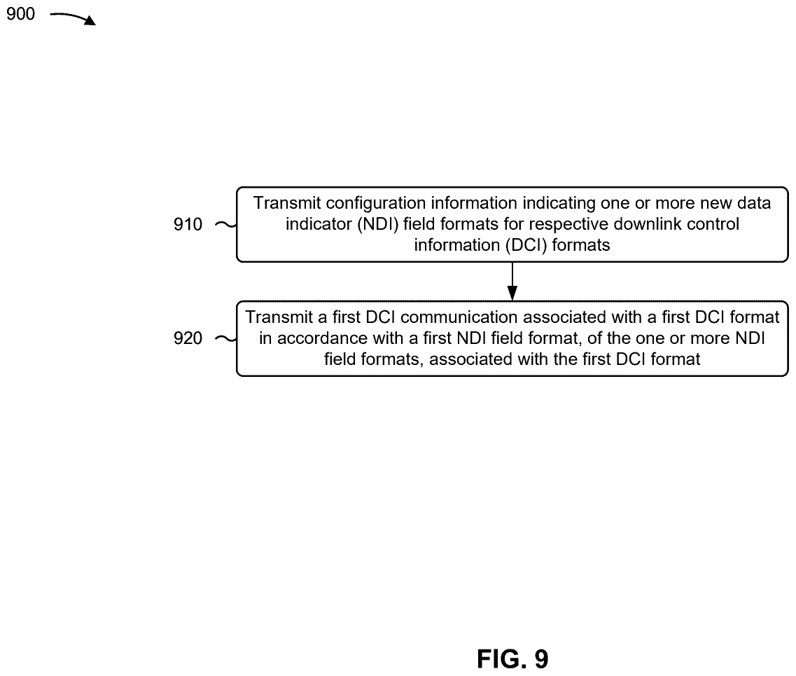

The network node 110, the controller/processor 240 of the network node 110, the UE 120, the controller/processor 280 of the UE 120, the CU 310, the DU 330, the RU 340, or any other component(s) of FIGS. 1, 2, or 3 may implement one or more techniques or perform one or more operations associated with NDI field formats for DCI, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 800 of FIG. 8, process 900 of FIG. 9, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 800 of FIG. 8, process 900 of FIG. 9, or other processes as described herein. In some examples, executing instructions may include running the instructions, converting the instructions, compiling the instructions, and/or interpreting the instructions, among other examples.

In some aspects, the UE 120 includes means for obtaining configuration information indicating one or more NDI field formats for respective DCI formats; and/or means for receiving a first DCI communication associated with a first DCI format associated with a first NDI field format, of the one or more NDI field formats, as indicated by the configuration information. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting configuration information indicating one or more NDI field formats for respective DCI formats; and/or means for transmitting a first DCI communication associated with a first DCI format in accordance with a first NDI field format, of the one or more NDI field formats, associated with the first DCI format. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

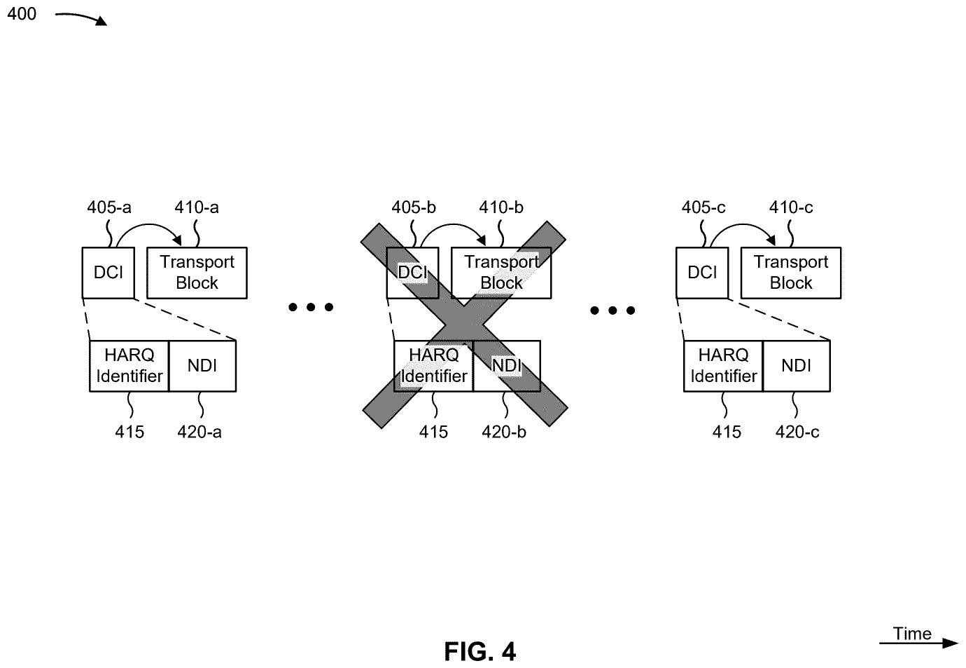

FIG. 4 is a diagram illustrating an examples 400 of signaling exchanged between a transmitting device and a receiving device (e.g., between a network node and a UE), in accordance with the present disclosure.

FIG. 4 illustrates an example where a UE fails to receive or decode the control information (for example, a DCI 405-b as shown in FIG. 4) scheduling a new transport block 410 (e.g., the transport block 410-b shown in FIG. 4) associated with a same HARQ identifier 415 as a previously transmitted transport block 410 (e.g., the transport block 410-a shown in FIG. 4). In some examples, the UE may essentially report a HARQ NACK to the network node related to the transport block 410-b. For example, the UE may transmit a HARQ NACK or the UE may not transmit any HARQ feedback associated with the transport block 410-b. In either case, the UE may indicate, to the network node, that the UE was unable to successfully decode the new transport block 410-b. However, in a case of a NACK to ACK error or discontinuous transmission (DTX) to ACK error (e.g., in which the UE did not transmit HARQ feedback but the network node decoded information as an ACK indication), the network node may subsequently schedule another transport block 410-c associated with the same HARQ identifier 415 (for example, while the UE has not successfully decoded the new transport block 410-b). As another example, the network node may transmit additional DCI 405-b to schedule the transport block 410-b. However, the UE may not receive, detect, or decode the additional DCI 405-b to schedule the transport block 410-b. After a certain quantity of attempts at scheduling and transmitting the transport block 410-b, the network node may move on to scheduling (e.g., via the DCI 405-c) and transmitting the transport block 410-c.

For example, the DCI 405-a may schedule the transmission of a first transport block 410-a, and may indicate that the transport block 410-a is associated with the HARQ identifier 415 and an NDI 420-a. The NDI 420-a may be associated with a first value (e.g., a single bit value). The UE may successfully receive and decode the transport block 410-a, and may transmit the HARQ ACK indicating the successful decoding of the transport block 410-a. Then, the network node may transmit the DCI 405-b to schedule the transmission of a second (e.g., different) transport block 410-b, and may indicate that the transport block 410-b is associated with the same HARQ identifier 415 and a different NDI 420-b (e.g., the NDI 420-b may have a different value than the NDI 420-a to indicate that a new transport block (e.g., the transport block 410-b) is being communicated for the HARQ identifier 415). However, the UE may not successfully detect, receive, or decode the DCI 405-b and/or subsequent DCI scheduling the transport block 410-b. After transmitting the DCI 405-b, the network node may transmit the DCI 405-c to schedule the transmission of a third (e.g., different) transport block 410-c, and may indicate that the transport block 410-c is associated with the same HARQ identifier 415 and a different NDI 420-c (e.g., the NDI 420-c may have a different value than the NDI 420-b to indicate that a new transport block (e.g., the transport block 410-c) is being communicated for the HARQ identifier 415).

However, in examples where an NDI field includes a single bit, the NDI 420-a associated with a first transport block 410-a may have the same value as the NDI 420-c associated with the third transport block 410-c. For example, the NDI 420-a may have a bit value of one (1). The network node may toggle the NDI for the NDI 420-b to a value of zero (0) to indicate a new transport block (e.g., the transport block 410-b) is being scheduled for the HARQ identifier 415. Later, the network node may toggle the NDI for the NDI 420-c to a value of one (1) to indicate a new transport block (e.g., the transport block 410-c) is being scheduled for the HARQ identifier 415.

In examples where the NDI 420-a and the NDI 420-c associated with the first transport blocks 410-a and the third transport blocks 410-c have the same value and the UE has failed to detect, decode, or otherwise receive the DCI 405-b scheduling the second transport block 410-b, the UE may incorrectly identify that the first transport block 410-a and the third transport block 410-c are the same transport block. For example, the UE 120 may incorrectly identify that the DCI 405-c is scheduling a retransmission of the transport block 410-a because the NDI 420-c has the same value as the NDI 420-a. Because the UE identifies that the first transport block 410-a and the third transport block 410-c are the same transport block, the UE may incorrectly perform one or more HARQ operations for the third transport block 410-c.

For example, in downlink scenarios, if the UE already successfully decoded the first transport block 410-a (e.g., and transmitted a HARQ ACK communication), then the UE may incorrectly discard or ignore the third transport block 410-c because the UE identifies that is has already successfully decoded the first transport block 410-a (e.g., resulting in the third transport block 410-c being lost). As another example, if the UE has not successfully decoded the first transport block 410-a (e.g., and transmitted a HARQ NACK communication), then the UE may attempt to combine (e.g., via soft combining or incremental redundancy combining) the first transport block 410-a and the third transport block 410-c. Because the first transport block 410-a and the third transport block 410-c are actually different transport blocks, the UE attempting to combine the first transport block 410-a and the third transport block 410-c may result in one or more decoding errors and consume processing resource associated with the UE attempting to combine different transport blocks. In uplink scenarios, the UE may incorrectly transmit a retransmission of the first transport block 410-a rather than transmitting the third (e.g., different) transport block 410-c using the uplink resources allocated or granted via the DCI 405-c. This may consume network resources and/or processing resources associated with the UE transmitting, and the network node receiving, the retransmission of the first transport block 410-a rather than transmitting the third (e.g., different) transport block 410-c. In sum, the UE incorrectly performing the one or more HARQ operations for the third transport block 410-c may consume network resources, processing resources, and/or power resources associated with the UE performing the one or more HARQ operations. In some examples, the UE incorrectly performing the one or more HARQ operations for the third transport block 410-c may result in the transport block 410-c being lost and/or increase latency associated with communicating the transport block 410-c, among other examples.

In some examples, to address the problems associated with a single bit NDI field, a size of the NDI field (e.g., an NDI bit-width) may be increased, such as to two bits (e.g., resulting in four possible values being indicated by the NDI field rather than only two possible values). In such examples, the NDI 420-a may have a first value (e.g., a bit value of “00”), the NDI 420-b may have a second value (e.g., a bit value of “01”), and the NDI 420-c may have a third value (e.g., a bit value of “10”). Because the NDI 420-a and the NDI 420-c have different values, the UE may correctly identify that the DCI 405-a and the DCI 405-c are scheduling different transport blocks. Therefore, increasing the size of the NDI field reduces the likelihood of the UE incorrectly identifying that DCIs are scheduling the same transport block. Further, increasing the size of the NDI field enables the UE to identify when a DCI has been missed or not received by the UE. For example, when a value of the NDI for a given HARQ identifier (e.g., the HARQ identifier 415) increases by more than a single step (e.g., modulo 4 in the example of a two-bit NDI field, such as from a bit value of “00” to a bit value of “10” in the example described above), the UE may identify that the DCI is scheduling a new transport block and that one or more transport blocks or DCI have been missed by the UE (e.g., because the UE expects the network node to toggle the NDI value by a single step for each new transport block associated with the HARQ identifier). This enables the UE to indicate to the network node that the one or more transport blocks or DCI have been missed by the UE, thereby enabling the network node to perform one or more actions to schedule and/or communicate the missed transport block(s).

However, increasing the size of the NDI field increases the size of the DCI payload. This increases signaling overhead associated with scheduling communications for the UE. The larger size NDI field may not be as useful in certain scenarios, which may result in unnecessarily increasing the signaling overhead associated with scheduling communications in those scenarios. For example, in uplink scenarios, the network node can identify that a scheduling DCI is missed by the UE based on uplink DMRS detection by the network node. Further, some DCI formats may not be configurable by the network node, such as DCI format 1_0 and/or DCI format 0_0. Therefore, increasing the size of the NDI field result in increased signaling overhead even in scenarios where the larger size NDI field may not be as useful or may not be needed.

As indicated above, FIG. 4 is provided as an example. Other examples may differ from what is described with regard to FIG. 4.

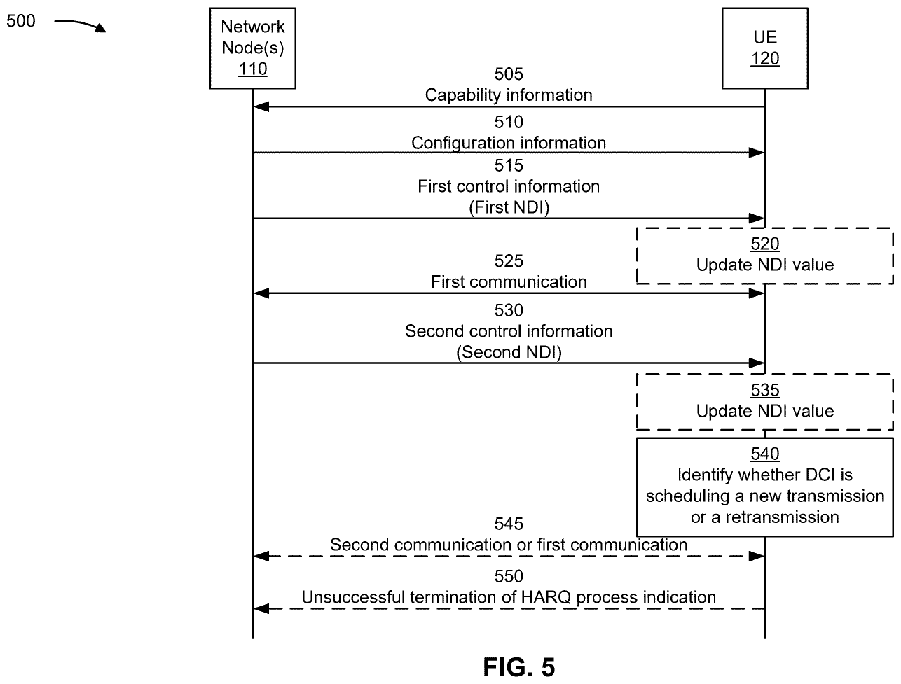

FIG. 5 is a diagram of an example 500 associated with signaling for NDI field formats for DCI, in accordance with the present disclosure. As shown in FIG. 5, a network node 110 (e.g., a base station, a CU, a DU, and/or an RU) may communicate with a UE 120. In some aspects, the network node and the UE may be part of a wireless network (e.g., the wireless communication network 100). The UE 120 and the network node 110 may have established a wireless connection prior to operations shown in FIG. 5.

In some aspects, as shown by reference number 505, the UE 120 may transmit, and the network node 110 may receive, capability information. The capability information may be included in a capability report. The UE 120 may transmit the capability information via an uplink communication, a sidelink communication, a unicast communication, a broadcast communication, a UE assistance information (UAI) communication, a UCI communication, a sidelink control information (SCI) communication, a MAC control element (MAC-CE) communication, an RRC communication, a PUCCH, a PUSCH, a PSCCH, and/or a PSSCH, among other examples. The capability information may indicate one or more parameters associated with respective capabilities of the UE. The one or more parameters may be indicated via respective information elements (IEs) included in a capability report.

The capability information may indicate whether the UE supports a feature and/or one or more parameters related to the feature. For example, the capability information may indicate a capability and/or parameter for supporting different NDI field formats and/or different NDI field sizes. As another example, the capability information may indicate a capability and/or parameter for being configured with different field formats and/or different NDI field sizes for a given DCI format. One or more operations described herein may be based on capability information. For example, the UE may perform a communication in accordance with the capability information, or may receive configuration information that is in accordance with the capability information.

In some aspects, the capability information may indicate whether the UE 120 supports receiving DCI communications having different NDI field formats for the same HARQ process (e.g., for the same HARQ process ID). For example, the capability information may indicate whether the UE supports different DCI formats having different NDI bit-widths for a given HARQ process. In some aspects, the capability information may indicate whether the UE 120 supports receiving different DCI formats having different quantity of bits for an NDI field. In some aspects, the capability information may indicate one or more supported NDI field sizes that the UE 120 supports (e.g., one bit NDI field, two bit NDI fields, three bit NDI fields, and/or other NDI field sizes).

The UE 120 and the network node 110 may communicate in accordance with the capability information. For example, if the capability information indicates that the UE 120 does not support different NDI field formats and/or different NDI field sizes, then the network node 110 may transmit DCI (e.g., associated with different DCI formats) having the same NDI field format and/or the same NDI field size. As another example, if the capability information indicates that the UE 120 does not support different DCI having different NDI field formats and/or different NDI field sizes for a given HARQ process, then the network node 110 may transmit DCI (e.g., associated with one or more DCI formats) having the same NDI field format and/or the same NDI field size for a given HARQ process. In other examples, the UE 120 and the network node 110 may communicate as described herein without the UE 120 transmitting the capability information.

As shown by reference number 510, the network node 110 may transmit, and the UE 120 may receive, configuration information. In some aspects, the UE 120 may receive the configuration information via one or more of system information (e.g., a master information block (MIB) and/or a system information block (SIB), among other examples), RRC signaling, MAC signaling (e.g., one or more MAC-CEs), and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC-CEs and/or one or more DCI messages, among other examples.

In some aspects, the configuration information may indicate that the UE 120 and the network node 110 are to use DCI formats having different NDI field formats and/or different NDI field sizes. For example, the configuration information may indicate that DCI formats having different NDI field formats and/or different NDI field sizes are enabled or allowed for communication(s) between the UE 120 and the network node 110.

In some aspects, the UE 120 may receive the configuration from the network node 110, as shown in FIG. 5. Additionally, or alternatively, the UE 120 may obtain the configuration from memory, such as from a configuration stored by the UE 120. For example, as used herein, “obtaining” the configuration information may refer to the UE 120 receiving (e.g., via over-the-air signaling) the configuration information and/or obtaining the configuration information from memory. For example, at least a portion (or all) of the configuration information described herein may be defined, or otherwise fixed, by a wireless communication standard, such as the 3GPP. In such examples, the UE 120 may store the configuration information, such as in an original equipment manufacturer (OEM) configuration or another stored configuration. This may be referred to as the configuration information being “hard coded” for the UE 120. In such examples, the configuration information may not be signaled to the UE 120 via over-the-air signaling. Instead, the UE 120 may obtain the configuration information from memory. In some aspects, the UE 120 may obtain a first portion of the configuration information described herein from the network node 110 (e.g., via over-the-air signaling) and may obtain second portion of the configuration information by retrieving the second portion from memory (e.g., from an OEM configuration).

In some aspects, the configuration information may indicate one or more NDI field formats for respective DCI formats. Each NDI field format, of the one or more NDI field formats, indicates a size of an NDI field associated with that NDI field format. For example, the configuration information may indicate an NDI field format (e.g., a size of an NDI field) for a given DCI format. In other words, the NDI field format or an NDI field size may be configurable for one or more DCI formats. The network node 110 may configure, for the UE 120, the NDI field format or an NDI field size for one or more DCI formats. The network node 110 may configure the one or more NDI field formats for a CC. For example, an NDI field size (e.g., a quantity of bits for NDI field or bitwidth) can be configured by the network node 110 (e.g., via RRC signaling) per DCI format and per CC.

In some aspects, the network node 110 may configure an NDI field size for one or more non-fallback DCI formats. “Non-fallback” DCI format refers to a DCI format that is configurable by the network node (e.g., that is not fixed or otherwise defined by a wireless communication standard, such as the 3GPP). For example, “fallback” DCI format refers to a DCI format that is not configurable by the network node 110. A fallback DCI format may be fixed by a wireless communication standard, such as the 3GPP.

In some aspects, the configuration information may indicate that a first one or more DCI formats associated with scheduling downlink transmissions are associated with different NDI field formats than a second one or more DCI formats that are associated with scheduling uplink transmissions. For example, DCI formats associated with scheduling downlink transmissions (e.g., DCI formats 1_0/1_1/1_2 or other DCI formats) may have 2-bit NDI field sizes while DCI formats associated with scheduling uplink transmissions (e.g., DCI formats 0_0/0_1/0_2) may have 1 bit NDI field sizes. This enables DCI scheduling downlink transmissions (e.g., which may have a higher likelihood of experiencing one or more of the problems described in more detail elsewhere herein) to have a larger NDI field size (e.g., thereby improving the reliability and/or performance of HARQ operations). Additionally, this enables DCI scheduling uplink transmissions (e.g., which may have a lower likelihood of experiencing one or more of the problems described in more detail elsewhere herein) to have a smaller NDI field size (e.g., thereby reducing a size of the DCI and reducing signaling overhead for scheduling uplink transmissions).

In some aspects, the configuration information may indicate that a first one or more DCI formats are associated with the first NDI field format and that a second one or more DCI formats are associated with a second NDI field format of the one or more NDI field formats. The first NDI field format may be associated with a first NDI field size and the second NDI field format may be associated with a second NDI field size. In some aspects, the first NDI field size is larger than the second NDI field size. In such examples, the first one or more DCI formats may include non-fallback DCI formats and the second one or more DCI formats may include fallback DCI formats. In other words, fallback DCI formats (e.g., DCI format 1_0 for downlink or DCI format 0_0 for uplink) may be configured to have a 1 bit NDI field size and non-fallback DCI formats (e.g., DCI formats 1_1 or 1_2 for downlink or DCI formats 0_1 or 0_2 for uplink) may be configured to have a 2 bit NDI field size. For example, because fallback DCI formats are not configurable by the network node 110, having the fallback DCI formats use a smaller NDI field size (e.g., a 1 bit NDI field size) may conserve signaling overhead that would have otherwise been associated with always transmitted the fallback DCI formats with a larger NDI field size (e.g., a 2 bit NDI field size).

In some other aspects, the first one or more DCI formats may include DCI formats associated with scheduling transmissions (e.g., uplink transmission, downlink transmissions, sidelink transmissions, or other transmissions) and the second one or more DCI formats may include DCI formats associated with a non-scheduling purpose. For example, the configuration information may indicate that DCI formats associated with downlink scheduling, uplink scheduling, or sidelink scheduling can have 2-bit NDI field size. The configuration information may indicate that DCI formats associated with other purposes (e.g., other than scheduling transmissions) have a 1 bit NDI field size (e.g., the DCI formats associated with other purposes may include DCI formats 2_0, 2_1, 2_2, 2_3, 2_4, 2_5, 2_6, or other DCI formats defined or otherwise fixed by the 3GPP).

In some aspects, the configuration information may indicate one or more restrictions associated with using DCI formats having different NDI field formats or different NDI field sizes in the context of a given HARQ process. For example, the configuration information may indicate that a given HARQ process ID (e.g., for downlink or uplink) cannot be indicated by different DCI formats if the different DCI formats have different NDI bit widths, different NDI field formats, or different NDI field sizes. For example, if a communication associated with a given HARQ process is scheduled via DCI having a given NDI field format (e.g., a first DCI format), then other DCI communications associated with the HARQ process ID may be associated with the first DCI format or a second DCI format that is associated with the given NDI field format. This may improve the likelihood that the UE 120 is able to identify whether a DCI communication is scheduling a new transmission or a retransmission for a given HARQ process because the DCI communications associated with the given HARQ process use the same NDI field format or the same NDI field sizes (e.g., enabling the UE 120 to easily compare the value(s) indicated by the NDI fields in the DCI communications).

As another example, the configuration information may indicate that a given HARQ process ID (e.g., for downlink or uplink) can be indicated by different DCI formats, but only for DCI scheduling a new transmission for the given HARQ process ID. For example, a restriction may include that any retransmissions for a given HARQ process ID are to be scheduled using DCI format(s) having the same NDI field format or NDI field size as a DCI format used to schedule the initial transmission. In other words, if an initial transmission of a transport block is scheduled by a DCI format with an X-bit NDI field, all retransmissions of the same transport block should be also scheduled by the same DCI format or by DCI format(s) that have an X-bit NDI field. This may improve the likelihood that the UE 120 is able to identify whether a DCI communication is scheduling a new transmission or a retransmission for a given HARQ process because the DCI communications scheduling retransmissions for the given HARQ process use the same NDI field format or the same NDI field sizes (e.g., enabling the UE 120 to easily compare the value(s) indicated by the NDI fields in the DCI communications). In such examples, if a DCI communication uses a different NDI field format or a different NDI field size than a last received DCI communication for the HARQ process, then the UE 120 may identify that the DCI communication is scheduling a new transmission (e.g., without having to compare actual values indicates by NDI fields having different sizes or formats).

In other aspects, the configuration information may indicate that there are no restrictions associated with using DCI formats having different NDI field formats or different NDI field sizes in the context of a given HARQ process. For example, the configuration information may indicate that HARQ process IDs can be reused across different DCI formats with different NDI field formats or different NDI field sizes (e.g., for new transmissions or for HARQ retransmissions).

The UE 120 may configure itself based at least in part on the configuration information. In some aspects, the UE 120 may be configured to perform one or more operations described herein based at least in part on the configuration information.

In some aspects, the configuration information described in connection with reference number 510 and/or the capability information described in connection with reference number 505 may include information transmitted via multiple communications. Additionally, or alternatively, the network node 110 may transmit the configuration information, or a communication including at least a portion of the configuration information, before and/or after the UE 120 transmits the c capability information. For example, the network node 110 may transmit a first portion of the configuration information before the UE 120 transmits the capability information, the UE 120 may transmit at least a portion of the capability information, and the network node 110 may transmit a second portion of the configuration information after receiving the capability information.

As shown by reference number 515, the network node 110 may transmit, and the UE 120 may receive, a first control channel communication scheduling a first communication (e.g., a first transport block). The first control channel communication may be a DCI communication. The first communication may be an uplink communication (e.g., a PUSCH communication), a downlink communication (e.g., a PDSCH communication), or a sidelink communication, among other examples. The first DCI communication may include a first NDI. For example, the first DCI communication may be associated with (e.g., may use) a first DCI format that is associated with (or configured with) a first NDI field format (e.g., a first NDI field size).

In some aspects, as shown by reference number 520, the UE 120 may update an NDI value that is stored and/or maintained by the UE 120. The NDI value may be a value that is used by the UE 120 to track whether new data is scheduled when different DCI formats using different NDI field formats or different NDI field sizes. The NDI value may have a size (e.g., a quantity of bits). The size may be based on a largest available or configurable NDI field size. For example, if the largest NDI field size for DCI formats is K bits, then the NDI value may have a size of K bits. The NDI value may be maintained for a given HARQ process. For example, the UE 120 may be configured with one or more HARQ process IDs. The UE 120 may maintained NDI values for respective HARQ process IDs of the one or more HARQ process IDs (e.g., the NDI values may be maintained on a per-HARQ process ID basis).

The UE 120 may update the NDI value based on the first NDI in the control channel communication received as described in connection with reference number 515. If the first NDI has the same size as the NDI value, then the UE 120 may update the NDI value to the first NDI (e.g., if the NDI value has a two bit size and the first NDI indicates a bit value of “01,” then the UE 120 may update the NDI value to the bit value of “01”). If the first NDI has a different size than the NDI value (e.g., is smaller than the size of the NDI value), then the UE 120 may update the NDI value based on a comparison of certain bits in the NDI value to the value indicated by the first NDI. The certain bits may be one or more MSBs or one or more LSBs in the NDI value. A quantity of the certain bits may be based on a size of the first NDI. For example, if the first NDI has a size of L bits, then the UE 120 may compare L MSBs or L LSBs from the NDI value to determine whether to update the NDI value.

For example, if the one or more MSBs or one or more LSBs in the NDI value match (e.g., are the same as) the value indicated by the first NDI, then the UE 120 may not change or modify the NDI value. If the one or more MSBs or one or more LSBs in the NDI value are different than the value indicated by the first NDI, then the UE 120 may update the NDI value. In such examples, the UE 120 may toggle or increment the NDI value by a step size. The step size may be a modulo 2^{K} in examples where the NDI value includes K bits. As an examples, if the NDI value includes two bits and a previous value of the NDI value is “00,” then the UE 120 may toggle or increment the NDI value by a modulo 4 value, such as to a bit value of “01.” If the NDI value changes, then the UE 120 may identify that the control channel communication is scheduling a new transmission for the HARQ process.

In some aspects, as shown by reference number 525, the UE 120 and the network node 110 may communicate the first communication (e.g., that is scheduled by the control information communication described in connection with reference number 515). For example, the UE 120 may transmit, and the network node 110 may receive, the first communication (e.g., if the first communication is an uplink communication, such as a PUSCH communication). In other aspects, the network node 110 may transmit and the UE 120 may receive, the first communication (e.g., if the first communication is a downlink communication, such as a PDSCH communication). In other aspects, the UE 120 may transmit, and another UE 120 (not shown in FIG. 5) may receive, the first communication (e.g., if the first communication is a sidelink communication).

As shown by reference number 530, the network node 110 may transmit, and the UE 120 may receive, a second control channel communication scheduling a second communication (e.g., a second transport block) or a retransmission of the first communication. The second control channel communication may be a DCI communication. The second communication may be an uplink communication (e.g., a PUSCH communication), a downlink communication (e.g., a PDSCH communication), or a sidelink communication, among other examples. The second DCI communication may include a second NDI. For example, the second DCI communication may be associated with (e.g., may use) the first DCI format or a second DCI format that is associated with (or configured with) a second NDI field format (e.g., a second NDI field size) or the first NDI field format. The second DCI communication may be associated with the same HARQ process ID as the first DCI communication (e.g., that is received by the UE 120 as described in connection with reference number 515).

In some aspects, as shown by reference number 535, the UE 120 may update the NDI value that is stored and/or maintained by the UE 120. The UE 120 may update the NDI value based on the second NDI in the control channel communication received as described in connection with reference number 530. If the second NDI has the same size as the NDI value, then the UE 120 may update the NDI value to the second NDI (e.g., if the NDI value has a two bit size and the second NDI indicates a bit value of “10,” then the UE 120 may update the NDI value to the bit value of “10”). If the second NDI has a different size than the NDI value, then the UE 120 may update the NDI value based on a comparison of certain bits in the NDI value to the value indicated by the first NDI. The certain bits may be one or more MSBs or one or more LSBs in the NDI value. For example, the UE 120 may update the NDI value using the second NDI in a similar manner as described above in connection with reference number 520.

As shown by reference number 540, the UE 120 may identify whether the second control information (e.g., the second DCI received as described in connection with reference number 530) is scheduling a new transmission (e.g., a new transport block) or a retransmission (e.g., of the first communication). In some aspects, the UE 120 may identify whether the second control information is scheduling a new transmission or a retransmission based on, or otherwise associated with the stored or maintained NDI value (e.g., the NDI value described in connection with reference number 520 and reference number 535). For example, if the NDI value has changed after updating the NDI value (e.g., as described in connection with reference number 535), then the UE 120 may identify that the second control information is scheduling a new transmission (e.g., a second communication or a second transport block). If the NDI value has not changed after updating the NDI value (e.g., as described in connection with reference number 535), then the UE 120 may identify that the second control information is scheduling a retransmission (e.g., of the first communication described above in connection with reference number 525).

As another example, the UE 120 may identify whether the second control information is scheduling a new transmission or a retransmission based on, or otherwise associated with a comparison of the first NDI and the second NDI. If the first NDI and the second NDI have the same size, then the UE 120 may compare the value indicated by the first NDI to the value indicated by the second NDI. If the values match, then the UE 120 may identify that the second control information is scheduling a retransmission (e.g., of the first communication described above in connection with reference number 525). If the values are different, then the UE 120 may identify that the second control information is scheduling a new transmission (e.g., a second communication or a second transport block).

As another example, if the first NDI and the second NDI have different sizes, then the UE 120 may identify that the second control information is scheduling a new transmission (e.g., a second communication or a second transport block) if there is a restriction that all HARQ retransmission be scheduled using DCI format(s) having the same NDI field format or NDI field size, as described in more detail elsewhere herein. As another example, if the first NDI and the second NDI have different sizes, then the UE 120 may identify whether the second control information is scheduling a new transmission or a retransmission based on, or otherwise associated with a comparison of certain bits (e.g., a subset of bits) from the larger NDI to the smaller NDI. For example, the certain bits (e.g., the subset of bits) may be one or more LSBs or one or more MSBs from the larger NDI. The quantity of the certain bits (e.g., the subset of bits) may be based on, or otherwise associated with, the size of the smaller NDI. For example, if the larger NDI (e.g., from the first NDI and the second NDI) has Y bits and the smaller NDI (e.g., from the first NDI and the second NDI) has Z bits, then the UE 120 may compare the Z bits from the smaller NDI to Z MSBs or Z LSBs from the larger NDI (e.g., from the Y total bits in the larger NDI). For example, if the larger NDI has a bit value of “01” and the smaller NDI has a bit value of “1” and the certain bits are one or more MSBs, then the UE 120 may compare the MSB from the larger NDI (e.g., a bit value of “0” from “01”) to the smaller NDI (e.g., a bit value of “1”) and identify that the NDI values do not match (e.g., thereby indicating that the second control information is scheduling a new transmission). As another example, if the certain bits are one or more LSBs, then the UE 120 may compare the MSB from the larger NDI (e.g., a bit value of “1” from “01”) to the smaller NDI (e.g., a bit value of “1”) and identify that the NDI values match (e.g., thereby indicating that the second control information is scheduling a retransmission).

In some aspects, as shown by reference number 545, the UE 120 and the network node 110 may communicate the second communication or a retransmission of the first communication (e.g., that is scheduled by the control information communication described in connection with reference number 530). For example, the UE 120 may transmit, and the network node 110 may receive, the second communication or the retransmission. In other aspects, the network node 110 may transmit and the UE 120 may receive, the second communication or the retransmission. In other aspects, the UE 120 may transmit, and another UE 120 (not shown in FIG. 5) may receive, the second communication or the retransmission.

In some aspects, the UE 120 may identify HARQ information based on the second NDI or the NDI value stored or maintained by the UE 120, such as when the second NDI or the NDI value stored or maintained by the UE 120 has a size larger than one (1) bit. For example, the UE 120 may identify whether the UE 120 missed or failed to receive one or more DCIs or transport blocks. As an example, if the second NDI or the NDI value stored or maintained by the UE 120 increases by more than a single step size or single increment (e.g., where the single step size or single increment is modulo 2^{K} in examples where the NDI size is K bits), then the UE 120 may identify that one or more DCIs or transport blocks have been missed by the UE 120. In such examples, as shown by reference number 550, the UE 120 may transmit, and the network node 110 may receive, an unsuccessful HARQ process termination indication that identifies an unsuccessful termination of a HARQ process associated with one or more transport blocks. This enables the network node 110 to reschedule or retransmit the missed communication(s).

As indicated above, FIG. 5 is provided as an example. Other examples may differ from what is described with respect to FIG. 5.

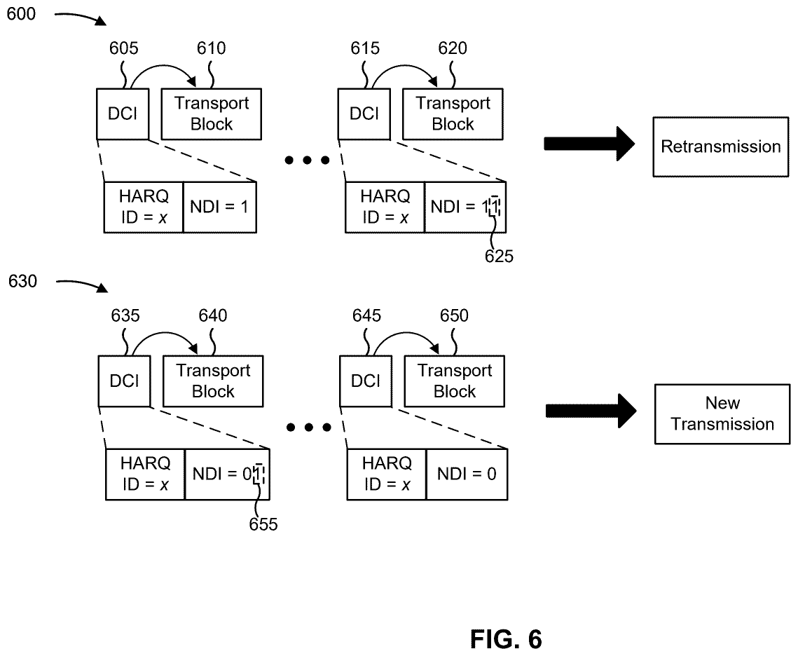

FIG. 6 is a diagram of examples associated with new data identifications for different NDI field formats, in accordance with the present disclosure. As shown in FIG. 6, a UE may receive DCI having different NDI field formats or different NDI field sizes for the same HARQ process ID (e.g., on the same cell and/or CC).

In an example 600, a UE may receive a DCI 605 that schedules a transport block 610. The DCI 605 may be associated with a HARQ ID x and may have an NDI field that has a 1 bit size (e.g., indicating a bit value of “1” as shown in FIG. 6). The UE may receive a DCI 615 that schedules a transport block 620. The DCI 615 may be associated with the HARQ ID x and may have an NDI field that has a 2 bit size (e.g., indicating a bit value of “11” as shown in FIG. 6). The UE may determine or identify whether the DCI 615 is scheduling a retransmission of the transport block 610 or a new transport block based on a comparison of one or more bits in the NDI field of the DCI 615 to the NDI value indicated by the DCI 605 (e.g., because the NDI field size of the DCI 605 is smaller than the NDI field size of the DCI 615). As an example, as shown in FIG. 6, the UE may compare a bit 625 (e.g., an LSB of the bit value of “11”) to the NDI value indicated by the DCI 605 to determine whether the DCI 615 is scheduling a retransmission of the transport block 610 or a new transport block. In the example shown in FIG. 6, the bit 625 and the NDI value indicated by the DCI 605 are both a bit value of “1.” Therefore, the UE may determine that the DCI 615 is scheduling a retransmission of the transport block 610.

In another example 630, the UE may receive a DCI 635 that schedules a transport block 640. The DCI 635 may be associated with a HARQ ID x and may have an NDI field that has a 2 bit size (e.g., indicating a bit value of “01” as shown in FIG. 6). The UE may receive a DCI 645 that schedules a transport block 650. The DCI 645 may be associated with the HARQ ID x and may have an NDI field that has a 1 bit size (e.g., indicating a bit value of “0” as shown in FIG. 6). The UE may determine or identify whether the DCI 645 is scheduling a retransmission of the transport block 640 or a new transport block based on a comparison of one or more bits in the NDI field of the DCI 635 to the NDI value indicated by the DCI 645 (e.g., because the NDI field size of the DCI 645 is smaller than the NDI field size of the DCI 635). As an example, as shown in FIG. 6, the UE may compare a bit 655 (e.g., an LSB of the bit value of “01”) to the NDI value indicated by the DCI 645 to determine whether the DCI 645 is scheduling a retransmission of the transport block 640 or a new transport block. In the example shown in FIG. 6, the bit 655 and the NDI value indicated by the DCI 645 are different (e.g., the bit 655 is “1” and the NDI value indicated by the DCI 645 is “0”). Therefore, the UE may determine that the DCI 615 is scheduling a new transmission (e.g., a new transport block).

As indicated above, FIG. 6 is provided as an example. Other examples may differ from what is described with respect to FIG. 6.

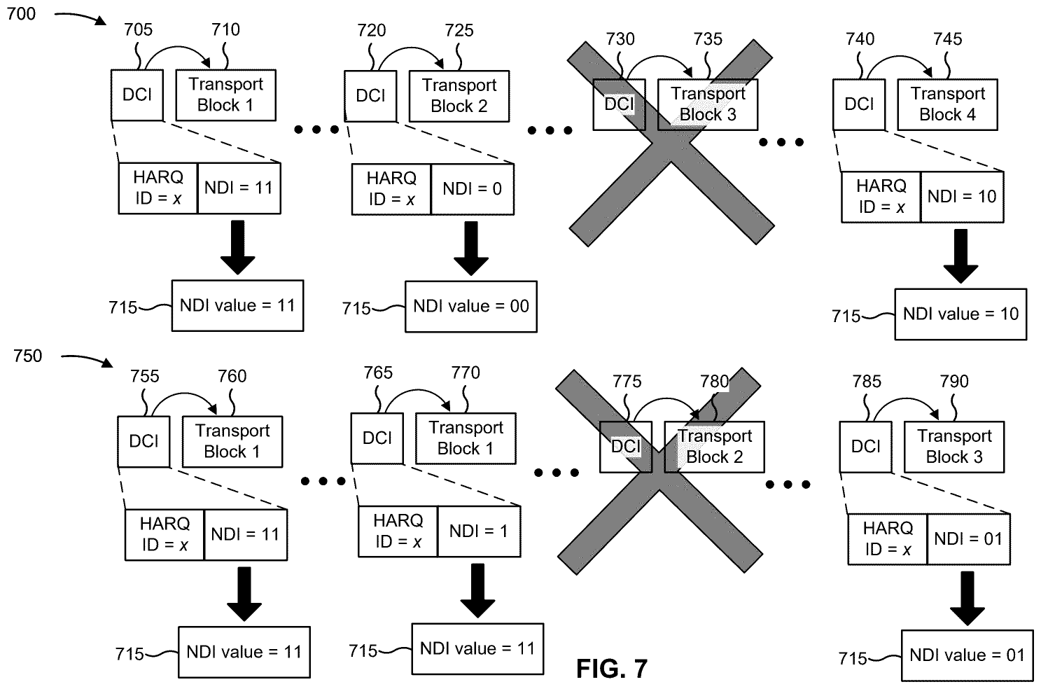

FIG. 7 is a diagram of examples associated with a stored or maintained NDI value, in accordance with the present disclosure. For example, a UE may store or maintain an NDI value to determine or identify whether received DCI for a given HARQ process ID is scheduling a new transmission or a HARQ retransmission. In the example shown in FIG. 7, the stored or maintained NDI value (e.g., NDI value 715) has a size of two bits. However, the NDI value 715 may have different sizes in other examples (e.g., three bits, four bits, or another quantity of bits).

As shown in FIG. 7 and an example 700, the UE may receive a DCI 705 that schedules a transport block 710 (e.g., a transport block 1). The DCI 705 may be associated with a HARQ process ID x. The DCI 705 may include an NDI that has an NDI field format or an NDI field size of two bits (e.g., indicating a bit value of “11” as shown in FIG. 7). Because the NDI field size is the same as the NDI value 715, the UE 120 may update the NDI value 715 to the NDI indicated by the DCI 705 (e.g., a bit value of “11”as shown in FIG. 7).

The UE may receive a DCI 720 that schedules a transport block 725. The DCI 720 may be associated with the HARQ process ID x. The DCI 720 may include an NDI that has an NDI field format or an NDI field size of one bit (e.g., indicating a bit value of “0” as shown in FIG. 7). The UE may compare certain bit(s) of the NDI value 715 (e.g., one or more MSBs or one or more LSBs) to the NDI indicated by the DCI 720 to determine whether to toggle or increment the NDI value 715. For example, as shown in FIG. 7, the UE may compare an MSB or an LSB of the NDI value 715 (e.g., both having a bit value of “1”) to the NDI indicated by the DCI 720 (e.g., having a bit value of “0”). Because the values are different, the UE may toggle or increment the NDI value 715 (e.g., by a step size) to a bit value of “00” as shown in FIG. 7. Because the NDI value 715 has changed (e.g., from “11” to “00”), the UE may identify that the DCI 720 is scheduling a new transmission (e.g., a transport block 2 as shown in FIG. 7).

A network node may transmit a DCI 730 that schedules a transport block 735. However, as shown in FIG. 7, the UE may fail to detect, decode, or otherwise receive the DCI 730 or subsequent DCI scheduling the transport block 735. At a later time, the UE may receive a DCI 740 that schedules a transport block 745. The DCI 740 may be associated with a HARQ process ID x. The DCI 740 may include an NDI that has an NDI field format or an NDI field size of two bits (e.g., indicating a bit value of “10” as shown in FIG. 7). Because the NDI field size is the same as the NDI value 715, the UE 120 may update the NDI value 715 to the NDI indicated by the DCI 740 (e.g., a bit value of “10” as shown in FIG. 7). The UE 120 may identify that the DCI 740 is scheduling a new transmission because the NDI value 715 has changed (e.g., from “00” to “10”). Additionally, because the NDI value 715 has changed by more than a single step size or single increment, the UE may identify that the DCI 730 and/or the transport block 735 were missed by the UE. For example, the UE may expect the NDI value 715 to change by a single step size or a single increment (e.g., to “01” from “00”). Because the NDI value 715 has changed by more than a single step size or single increment, the UE may identify that the one or more DCI communications or transport blocks were missed by the UE 120. In some aspects, the UE may transmit, to the network node, an indication that the NDI value 715 has changed by more than a single step size or single increment, the UE may identify that the DCI 730 and/or the transport block 735 were missed by the UE.

In an example 750, the UE may receive a DCI 755 that schedules a transport block 760 (e.g., a transport block 1). The DCI 755 may be associated with a HARQ process ID x. The DCI 755 may include an NDI that has an NDI field format or an NDI field size of two bits (e.g., indicating a bit value of “11” as shown in FIG. 7). Because the NDI field size is the same as the NDI value 715, the UE 120 may update the NDI value 715 to the NDI indicated by the DCI 755 (e.g., a bit value of “11” as shown in FIG. 7).

The UE may receive a DCI 765 that schedules a transport block 770. The DCI 765 may be associated with the HARQ process ID x. The DCI 765 may include an NDI that has an NDI field format or an NDI field size of one bit (e.g., indicating a bit value of “1” as shown in FIG. 7). The UE may compare certain bit(s) of the NDI value 715 (e.g., one or more MSBs or one or more LSBs) to the NDI indicated by the DCI 765 to determine whether to toggle or increment the NDI value 715. For example, as shown in FIG. 7, the UE may compare an MSB or an LSB of the NDI value 715 (e.g., both having a bit value of “1”) to the NDI indicated by the DCI 765 (e.g., having a bit value of “1”). Because the values are the same, the UE may not toggle or increment the NDI value 715 and may keep the NDI value 715 having the bit value of “11”as shown in FIG. 7. Because the NDI value 715 has remained the same, the UE may identify that the DCI 765 is scheduling a retransmission of the transport block 760 (e.g., the transport block 1 as shown in FIG. 7).

A network node may transmit a DCI 775 that schedules a transport block 780. However, as shown in FIG. 7, the UE may fail to detect, decode, or otherwise receive the DCI 775 or subsequent DCI scheduling the transport block 780. At a later time, the UE may receive a DCI 785 that schedules a transport block 790. The DCI 785 may be associated with the HARQ process ID x. The DCI 785 may include an NDI that has an NDI field format or an NDI field size of two bits (e.g., indicating a bit value of “01” as shown in FIG. 7). Because the NDI field size is the same as the NDI value 715, the UE 120 may update the NDI value 715 to the NDI indicated by the DCI 785 (e.g., a bit value of “01” as shown in FIG. 7). The UE 120 may identify that the DCI 785 is scheduling a new transmission because the NDI value 715 has changed (e.g., from “11” to “01”). Additionally, because the NDI value 715 has changed by more than a single step size or single increment, the UE may identify that the DCI 775 and/or the transport block 780 were missed by the UE. For example, the UE may expect the NDI value 715 to change by a single step size or a single increment (e.g., to “00” from “11”). Because the NDI value 715 has changed by more than a single step size or single increment, the UE may identify that the one or more DCI communications or transport blocks were missed by the UE 120. In some aspects, the UE may transmit, to the network node, an indication that the NDI value 715 has changed by more than a single step size or single increment, the UE may identify that the DCI 775 and/or the transport block 780 were missed by the UE.

As indicated above, FIG. 7 is provided as an example. Other examples may differ from what is described with respect to FIG. 7.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with NDI field formats for DCI.

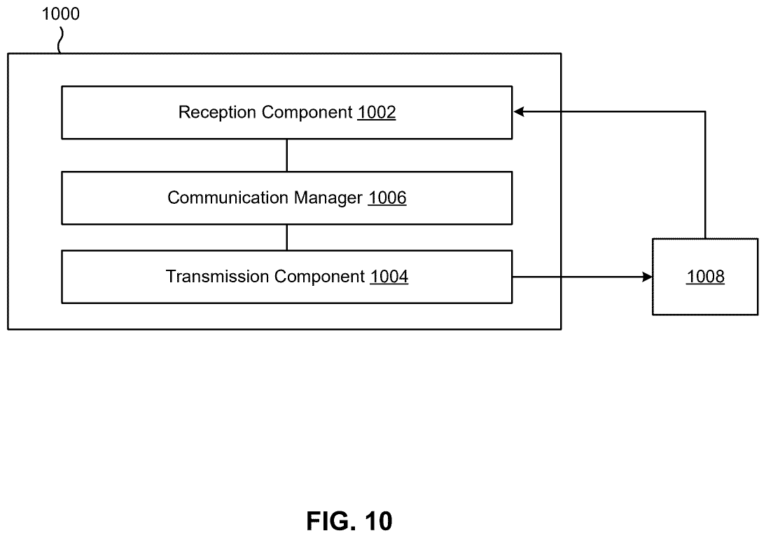

As shown in FIG. 8, in some aspects, process 800 may include obtaining configuration information indicating one or more NDI field formats for respective DCI formats (block 810). For example, the UE (e.g., using reception component 1002 and/or communication manager 1006, depicted in FIG. 10) may obtain configuration information indicating one or more NDI field formats for respective DCI formats, as described above.

As further shown in FIG. 8, in some aspects, process 800 may include receiving a first DCI communication associated with a first DCI format associated with a first NDI field format, of the one or more NDI field formats, as indicated by the configuration information (block 820). For example, the UE (e.g., using reception component 1002 and/or communication manager 1006, depicted in FIG. 10) may receive a first DCI communication associated with a first DCI format associated with a first NDI field format, of the one or more NDI field formats, as indicated by the configuration information, as described above.

Process 800 may include additional aspects, such as any single aspect or any combination of aspects described below and/or in connection with one or more other processes described elsewhere herein.

In a first aspect, each NDI field format, of the one or more NDI field formats, indicates a size of an NDI field associated with that NDI field format.

In a second aspect, alone or in combination with the first aspect, the one or more NDI field formats are configured for a component carrier.

In a third aspect, alone or in combination with one or more of the first and second aspects, the respective DCI formats include non-fallback DCI formats.

In a fourth aspect, alone or in combination with one or more of the first through third aspects, the configuration information indicates that a first one or more DCI formats associated with scheduling downlink transmissions are associated with different NDI field formats than a second one or more DCI formats that are associated with scheduling uplink transmissions.

In a fifth aspect, alone or in combination with one or more of the first through fourth aspects, the configuration information indicates that a first one or more DCI formats, including the first DCI format, are associated with the first NDI field format, and the configuration information indicates that a second one or more DCI formats are associated with a second NDI field format of the one or more NDI field formats.

In a sixth aspect, alone or in combination with one or more of the first through fifth aspects, the first NDI field format is associated with a first NDI field size and the second NDI field format is associated with a second NDI field size, where the first NDI field size is larger than the second NDI field size, and the first one or more DCI formats include non-fallback DCI formats and the second one or more DCI formats include fallback DCI formats.

In a seventh aspect, alone or in combination with one or more of the first through sixth aspects, the first DCI communication is associated with a HARQ process identifier, and other DCI communications associated with the HARQ process identifier are associated with the first DCI format or a second DCI format that is associated with the first NDI field format.

In an eighth aspect, alone or in combination with one or more of the first through seventh aspects, the first DCI communication is associated with a HARQ process identifier, where the first DCI communication schedules a transport block, and other DCI communications, scheduling respective retransmissions of the transport block, are associated with the first DCI format or a second DCI format that is associated with the first NDI field format.

In a ninth aspect, alone or in combination with one or more of the first through eighth aspects, the first DCI communication is associated with a HARQ process identifier, where the first DCI communication schedules a first transport block, and process 800 includes receiving a second DCI communication, associated with the HARQ process identifier, scheduling a second transport block, where the second DCI communication is associated with a second NDI field format of the one or more NDI field formats.

In a tenth aspect, alone or in combination with one or more of the first through ninth aspects, process 800 includes identifying that the second DCI communication is scheduling the second transport block based on the second DCI communication being associated with the second NDI field format.

In an eleventh aspect, alone or in combination with one or more of the first through tenth aspects, the first DCI communication is associated with a HARQ process identifier, where the first DCI communication schedules a first transport block, and process 800 includes receiving a second DCI communication, associated with the HARQ process identifier, scheduling a retransmission of the transport block or scheduling a second transport block, where the second DCI communication is associated with a second NDI field format of the one or more NDI field formats.

In a twelfth aspect, alone or in combination with one or more of the first through eleventh aspects, the first NDI field format is associated with a first NDI field size of a first quantity of bits, where the second NDI field format is associated with a second NDI field size of a second quantity of bits, and process 800 includes identifying whether the second DCI communication schedules the retransmission of the transport block or schedules the second transport block based on a comparison of a first one or more bits included in a first NDI field of the first DCI communication to a second one or more bits included in a second NDI field of the second DCI communication.

In a thirteenth aspect, alone or in combination with one or more of the first through twelfth aspects, the first NDI field size is larger than the second NDI field size, and the first one or more bits include one or more least significant bits or one or more most significant bits included in the first NDI field, and the second one or more bits include all bits included in the second NDI field.

In a fourteenth aspect, alone or in combination with one or more of the first through thirteenth aspects, a third quantity of bits included in the first one or more bits is the second quantity of bits.

In a fifteenth aspect, alone or in combination with one or more of the first through fourteenth aspects, the first NDI field size is smaller than the second NDI field size, and the first one or more bits include all bits included in the first NDI field, and the second one or more bits include one or more least significant bits or one or more most significant bits included in the second NDI field.

In a sixteenth aspect, alone or in combination with one or more of the first through fifteenth aspects, process 800 includes identifying, after receiving the first DCI communication, a first NDI value associated with the HARQ process identifier based on a first one or more bits included in a first NDI field of the first DCI communication and a previous NDI value associated with the HARQ process identifier, identifying, after receiving the second DCI communication, a second NDI value associated with the HARQ process identifier based on a second one or more bits included in a second NDI field of the second DCI communication and the first NDI value, and identifying whether the second DCI communication schedules the retransmission of the transport block or schedules the second transport block based on a comparison of the first NDI value to the second NDI value.

In a seventeenth aspect, alone or in combination with one or more of the first through sixteenth aspects, the first NDI value and the second NDI value are a same value, and identifying whether the second DCI communication schedules the retransmission of the transport block or schedules the second transport block includes identifying that the second DCI communication schedules the retransmission of the transport block based on the first NDI value and the second NDI value being the same value.

In an eighteenth aspect, alone or in combination with one or more of the first through seventeenth aspects, identifying whether the second DCI communication schedules the retransmission of the transport block or schedules the second transport block includes identifying that the second DCI communication schedules the second transport block based on the first NDI value and the second NDI value being different values.

In a nineteenth aspect, alone or in combination with one or more of the first through eighteenth aspects, the first NDI value and the second NDI value are values of a stored NDI field for the HARQ process identifier.

In a twentieth aspect, alone or in combination with one or more of the first through nineteenth aspects, the first NDI field format is associated with a first NDI field size and the second NDI field format is associated with a second NDI field size, and the first NDI value and the second NDI value have a size that is based on a larger size among the first NDI field size and the second NDI field size.

In a twenty-first aspect, alone or in combination with one or more of the first through twentieth aspects, the first NDI value and the previous NDI value have a size, where the first NDI field format is associated with the size, where the first NDI value is a value indicated by an NDI field included in the first DCI communication.

In a twenty-second aspect, alone or in combination with one or more of the first through twenty-first aspects, the first NDI value and the previous NDI value have a first size, where the first NDI field format is associated with a second size that is smaller than the first size, and identifying the first NDI value includes identifying the first NDI value based on a comparison of a third one or more bits included in the previous NDI value to a value indicated by an NDI field included in the first DCI communication.

In a twenty-third aspect, alone or in combination with one or more of the first through twenty-second aspects, the first NDI value is the previous NDI value based on the first one or more bits indicating a same value as the value.

In a twenty-fourth aspect, alone or in combination with one or more of the first through twenty-third aspects, the first NDI value is an incremented value from the previous NDI value based on the first one or more bits indicating a different value than the value.

In a twenty-fifth aspect, alone or in combination with one or more of the first through twenty-fourth aspects, the first one or more bits include a one or more most significant bits or one or more least significant bits included in the previous NDI value.

In a twenty-sixth aspect, alone or in combination with one or more of the first through twenty-fifth aspects, a quantity of bits included in the first one or more bits is based on the second size.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with NDI field formats for DCI.

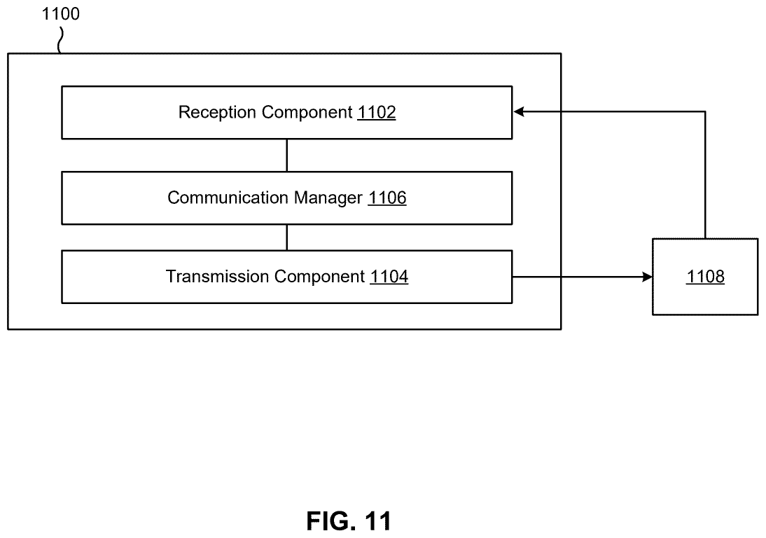

As shown in FIG. 9, in some aspects, process 900 may include transmitting configuration information indicating one or more NDI field formats for respective DCI formats (block 910). For example, the network node (e.g., using transmission component 1104 and/or communication manager 1106, depicted in FIG. 11) may transmit configuration information indicating one or more NDI field formats for respective DCI formats, as described above.

As further shown in FIG. 9, in some aspects, process 900 may include transmitting a first DCI communication associated with a first DCI format in accordance with a first NDI field format, of the one or more NDI field formats, associated with the first DCI format (block 920). For example, the network node (e.g., using transmission component 1104 and/or communication manager 1106, depicted in FIG. 11) may transmit a first DCI communication associated with a first DCI format in accordance with a first NDI field format, of the one or more NDI field formats, associated with the first DCI format, as described above.

Process 900 may include additional aspects, such as any single aspect or any combination of aspects described below and/or in connection with one or more other processes described elsewhere herein.

In a first aspect, each NDI field format, of the one or more NDI field formats, indicates a size of an NDI field associated with that NDI field format.

In a second aspect, alone or in combination with the first aspect, the one or more NDI field formats are configured for a component carrier.

In a third aspect, alone or in combination with one or more of the first and second aspects, the respective DCI formats include non-fallback DCI formats.

In a fourth aspect, alone or in combination with one or more of the first through third aspects, the configuration information indicates that a first one or more DCI formats associated with scheduling downlink transmissions are associated with different NDI field formats than a second one or more DCI formats that are associated with scheduling uplink transmissions.

In a fifth aspect, alone or in combination with one or more of the first through fourth aspects, the configuration information indicates that a first one or more DCI formats, including the first DCI format, are associated with the first NDI field format, and the configuration information indicates that a second one or more DCI formats are associated with a second NDI field format of the one or more NDI field formats.

In a sixth aspect, alone or in combination with one or more of the first through fifth aspects, the first NDI field format is associated with a first NDI field size and the second NDI field format is associated with a second NDI field size, where the first NDI field size is larger than the second NDI field size, and the first one or more DCI formats include non-fallback DCI formats and the second one or more DCI formats include fallback DCI formats.

In a seventh aspect, alone or in combination with one or more of the first through sixth aspects, the first DCI communication is associated with a HARQ process identifier, and other DCI communications associated with the HARQ process identifier are associated with the first DCI format or a second DCI format that is associated with the first NDI field format.

In an eighth aspect, alone or in combination with one or more of the first through seventh aspects, the first DCI communication is associated with a HARQ process identifier, where the first DCI communication schedules a transport block, and other DCI communications, scheduling respective retransmissions of the transport block, are associated with the first DCI format or a second DCI format that is associated with the first NDI field format.

In a ninth aspect, alone or in combination with one or more of the first through eighth aspects, the first DCI communication is associated with a HARQ process identifier, where the first DCI communication schedules a first transport block, and process 900 includes transmitting a second DCI communication, associated with the HARQ process identifier, scheduling a second transport block, where the second DCI communication is associated with a second NDI field format of the one or more NDI field formats.

In a tenth aspect, alone or in combination with one or more of the first through ninth aspects, the first DCI communication is associated with a HARQ process identifier, where the first DCI communication schedules a first transport block, and process 900 includes transmitting a second DCI communication, associated with the HARQ process identifier, scheduling a retransmission of the transport block or scheduling a second transport block, where the second DCI communication is associated with a second NDI field format of the one or more NDI field formats.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 5-7. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 1 and FIG. 2. Additionally, or alternatively, one or more components shown in FIG. 10 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may obtain configuration information indicating one or more NDI field formats for respective DCI formats. The reception component 1002 may receive a first DCI communication associated with a first DCI format associated with a first NDI field format, of the one or more NDI field formats, as indicated by the configuration information.

The communication manager 1006 may identify that the second DCI communication is scheduling the second transport block based on the second DCI communication being associated with the second NDI field format.

The communication manager 1006 may identify, after receiving the first DCI communication, a first NDI value associated with the HARQ process identifier based on a first one or more bits included in a first NDI field of the first DCI communication and a previous NDI value associated with the HARQ process identifier.

The communication manager 1006 may identify, after receiving the second DCI communication, a second NDI value associated with the HARQ process identifier based on a second one or more bits included in a second NDI field of the second DCI communication and the first NDI value.

The communication manager 1006 may identify whether the second DCI communication schedules the retransmission of the transport block or schedules the second transport block based on a comparison of the first NDI value to the second NDI value.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 5-7. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the network node described in connection with FIG. 1 and FIG. 2. Additionally, or alternatively, one or more components shown in FIG. 11 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit configuration information indicating one or more NDI field formats for respective DCI formats. The transmission component 1104 may transmit a first DCI communication associated with a first DCI format in accordance with a first NDI field format, of the one or more NDI field formats, associated with the first DCI format.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: obtaining configuration information indicating one or more new data indicator (NDI) field formats for respective downlink control information (DCI) formats; and receiving a first DCI communication associated with a first DCI format associated with a first NDI field format, of the one or more NDI field formats, as indicated by the configuration information.

Aspect 2: The method of Aspect 1, wherein each NDI field format, of the one or more NDI field formats, indicates a size of an NDI field associated with that NDI field format.

Aspect 3: The method of any of Aspects 1-2, wherein the one or more NDI field formats are configured for a component carrier.

Aspect 4: The method of any of Aspects 1-3, wherein the respective DCI formats include non-fallback DCI formats.

Aspect 5: The method of any of Aspects 1-4, wherein the configuration information indicates that a first one or more DCI formats associated with scheduling downlink transmissions are associated with different NDI field formats than a second one or more DCI formats that are associated with scheduling uplink transmissions.

Aspect 6: The method of any of Aspects 1-5, wherein the configuration information indicates that a first one or more DCI formats, including the first DCI format, are associated with the first NDI field format, and wherein the configuration information indicates that a second one or more DCI formats are associated with a second NDI field format of the one or more NDI field formats.

Aspect 7: The method of Aspect 6, wherein the first NDI field format is associated with a first NDI field size and the second NDI field format is associated with a second NDI field size, wherein the first NDI field size is larger than the second NDI field size, and wherein the first one or more DCI formats include non-fallback DCI formats and the second one or more DCI formats include fallback DCI formats.

Aspect 8: The method of any of Aspects 1-7, wherein the first DCI communication is associated with a hybrid automatic repeat request (HARQ) process identifier, and wherein other DCI communications associated with the HARQ process identifier are associated with the first DCI format or a second DCI format that is associated with the first NDI field format.

Aspect 9: The method of any of Aspects 1-8, wherein the first DCI communication is associated with a hybrid automatic repeat request (HARQ) process identifier, wherein the first DCI communication schedules a transport block, and wherein other DCI communications, scheduling respective retransmissions of the transport block, are associated with the first DCI format or a second DCI format that is associated with the first NDI field format.

Aspect 10: The method of any of Aspects 1-9, wherein the first DCI communication is associated with a hybrid automatic repeat request (HARQ) process identifier, wherein the first DCI communication schedules a first transport block, and the method further comprising: receiving a second DCI communication, associated with the HARQ process identifier, scheduling a second transport block, wherein the second DCI communication is associated with a second NDI field format of the one or more NDI field formats.

Aspect 11: The method of Aspect 10, further comprising: identifying that the second DCI communication is scheduling the second transport block based on the second DCI communication being associated with the second NDI field format.

Aspect 12: The method of any of Aspects 1-11, wherein the first DCI communication is associated with a hybrid automatic repeat request (HARQ) process identifier, wherein the first DCI communication schedules a first transport block, and the method further comprising: receiving a second DCI communication, associated with the HARQ process identifier, scheduling a retransmission of the transport block or scheduling a second transport block, wherein the second DCI communication is associated with a second NDI field format of the one or more NDI field formats.

Aspect 13: The method of Aspect 12, wherein the first NDI field format is associated with a first NDI field size of a first quantity of bits, wherein the second NDI field format is associated with a second NDI field size of a second quantity of bits, and the method further comprising: identifying whether the second DCI communication schedules the retransmission of the transport block or schedules the second transport block based on a comparison of a first one or more bits included in a first NDI field of the first DCI communication to a second one or more bits included in a second NDI field of the second DCI communication.

Aspect 14: The method of Aspect 13, wherein the first NDI field size is larger than the second NDI field size, and wherein the first one or more bits include one or more least significant bits or one or more most significant bits included in the first NDI field, and wherein the second one or more bits include all bits included in the second NDI field.

Aspect 15: The method of Aspect 14, wherein a third quantity of bits included in the first one or more bits is the second quantity of bits.

Aspect 16: The method of Aspect 13, wherein the first NDI field size is smaller than the second NDI field size, and wherein the first one or more bits include all bits included in the first NDI field, and wherein the second one or more bits include one or more least significant bits or one or more most significant bits included in the second NDI field.

Aspect 17: The method of any of Aspects 12-16, further comprising: identifying, after receiving the first DCI communication, a first NDI value associated with the HARQ process identifier based on a first one or more bits included in a first NDI field of the first DCI communication and a previous NDI value associated with the HARQ process identifier; identifying, after receiving the second DCI communication, a second NDI value associated with the HARQ process identifier based on a second one or more bits included in a second NDI field of the second DCI communication and the first NDI value; and identifying whether the second DCI communication schedules the retransmission of the transport block or schedules the second transport block based on a comparison of the first NDI value to the second NDI value.

Aspect 18: The method of Aspect 17, wherein the first NDI value and the second NDI value are a same value, and wherein identifying whether the second DCI communication schedules the retransmission of the transport block or schedules the second transport block comprises: identifying that the second DCI communication schedules the retransmission of the transport block based on the first NDI value and the second NDI value being the same value.

Aspect 19: The method of Aspect 17, wherein identifying whether the second DCI communication schedules the retransmission of the transport block or schedules the second transport block comprises: identifying that the second DCI communication schedules the second transport block based on the first NDI value and the second NDI value being different values.

Aspect 20: The method of Aspect 17, wherein the first NDI value and the second NDI value are values of a stored NDI field for the HARQ process identifier.

Aspect 21: The method of Aspect 17, wherein the first NDI field format is associated with a first NDI field size and the second NDI field format is associated with a second NDI field size, and wherein the first NDI value and the second NDI value have a size that is based on a larger size among the first NDI field size and the second NDI field size.

Aspect 22: The method of Aspect 17, wherein the first NDI value and the previous NDI value have a size, wherein the first NDI field format is associated with the size, wherein the first NDI value is a value indicated by an NDI field included in the first DCI communication.

Aspect 23: The method of Aspect 17, wherein the first NDI value and the previous NDI value have a first size, wherein the first NDI field format is associated with a second size that is smaller than the first size, and wherein identifying the first NDI value comprises: identifying the first NDI value based on a comparison of a third one or more bits included in the previous NDI value to a value indicated by an NDI field included in the first DCI communication.

Aspect 24: The method of Aspect 23, wherein the first NDI value is the previous NDI value based on the first one or more bits indicating a same value as the value.

Aspect 25: The method of Aspect 23, wherein the first NDI value is an incremented value from the previous NDI value based on the first one or more bits indicating a different value than the value.

Aspect 26: The method of any of Aspects 23-25, wherein the first one or more bits include a one or more most significant bits or one or more least significant bits included in the previous NDI value.

Aspect 27: The method of any of Aspects 23-26, wherein a quantity of bits included in the first one or more bits is based on the second size.

Aspect 28: A method of wireless communication performed by a network node, comprising: transmitting configuration information indicating one or more new data indicator (NDI) field formats for respective downlink control information (DCI) formats; and transmitting a first DCI communication associated with a first DCI format in accordance with a first NDI field format, of the one or more NDI field formats, associated with the first DCI format.

Aspect 29: The method of Aspect 28, wherein each NDI field format, of the one or more NDI field formats, indicates a size of an NDI field associated with that NDI field format.

Aspect 30: The method of any of Aspects 28-29, wherein the one or more NDI field formats are configured for a component carrier.

Aspect 31: The method of any of Aspects 28-30, wherein the respective DCI formats include non-fallback DCI formats.

Aspect 32: The method of any of Aspects 28-31, wherein the configuration information indicates that a first one or more DCI formats associated with scheduling downlink transmissions are associated with different NDI field formats than a second one or more DCI formats that are associated with scheduling uplink transmissions.

Aspect 33: The method of any of Aspects 28-32, wherein the configuration information indicates that a first one or more DCI formats, including the first DCI format, are associated with the first NDI field format, and wherein the configuration information indicates that a second one or more DCI formats are associated with a second NDI field format of the one or more NDI field formats.

Aspect 34: The method of Aspect 33, wherein the first NDI field format is associated with a first NDI field size and the second NDI field format is associated with a second NDI field size, wherein the first NDI field size is larger than the second NDI field size, and wherein the first one or more DCI formats include non-fallback DCI formats and the second one or more DCI formats include fallback DCI formats.

Aspect 35: The method of any of Aspects 28-34, wherein the first DCI communication is associated with a hybrid automatic repeat request (HARQ) process identifier, and wherein other DCI communications associated with the HARQ process identifier are associated with the first DCI format or a second DCI format that is associated with the first NDI field format.

Aspect 36: The method of any of Aspects 28-35, wherein the first DCI communication is associated with a hybrid automatic repeat request (HARQ) process identifier, wherein the first DCI communication schedules a transport block, and wherein other DCI communications, scheduling respective retransmissions of the transport block, are associated with the first DCI format or a second DCI format that is associated with the first NDI field format.

Aspect 37: The method of any of Aspects 28-36, wherein the first DCI communication is associated with a hybrid automatic repeat request (HARQ) process identifier, wherein the first DCI communication schedules a first transport block, and the method further comprising: transmitting a second DCI communication, associated with the HARQ process identifier, scheduling a second transport block, wherein the second DCI communication is associated with a second NDI field format of the one or more NDI field formats.

Aspect 38: The method of any of Aspects 28-37, wherein the first DCI communication is associated with a hybrid automatic repeat request (HARQ) process identifier, wherein the first DCI communication schedules a first transport block, and the method further comprising: transmitting a second DCI communication, associated with the HARQ process identifier, scheduling a retransmission of the transport block or scheduling a second transport block, wherein the second DCI communication is associated with a second NDI field format of the one or more NDI field formats.

Aspect 39: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-38.

Aspect 40: An apparatus for wireless communication at a device, the apparatus comprising one or more memories and one or more processors coupled to the one or more memories, the one or more processors configured to cause the device to perform the method of one or more of Aspects 1-38.

Aspect 41: An apparatus for wireless communication, the apparatus comprising at least one means for performing the method of one or more of Aspects 1-38.

Aspect 42: A non-transitory computer-readable medium storing code for wireless communication, the code comprising instructions executable by one or more processors to perform the method of one or more of Aspects 1-38.

Aspect 43: A non-transitory computer-readable medium storing a set of instructions for wireless communication, the set of instructions comprising one or more instructions that, when executed by one or more processors of a device, cause the device to perform the method of one or more of Aspects 1-38.

Aspect 44: A device for wireless communication, the device comprising a processing system that includes one or more processors and one or more memories coupled with the one or more processors, the processing system configured to cause the device to perform the method of one or more of Aspects 1-38.

Aspect 45: An apparatus for wireless communication at a device, the apparatus comprising one or more memories and one or more processors coupled to the one or more memories, the one or more processors individually or collectively configured to cause the device to perform the method of one or more of Aspects 1-38.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more. ” Further, as used herein, the article “the” is intended to include one or more items referenced in connection with the article “the” and may be used interchangeably with “the one or more. ” Furthermore, as used herein, the terms “set” and “group” are intended to include one or more items and may be used interchangeably with “one or more. ” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
obtain configuration information indicating one or more new data indicator (NDI) field formats for respective downlink control information (DCI) formats; and
receive a first DCI communication associated with a first DCI format associated with a first NDI field format, of the one or more NDI field formats, as indicated by the configuration information.

2. The UE of claim 1, wherein the configuration information indicates that a first one or more DCI formats associated with scheduling downlink transmissions are associated with different NDI field formats than a second one or more DCI formats that are associated with scheduling uplink transmissions.

3. The UE of claim 1, wherein the configuration information indicates that a first one or more DCI formats, including the first DCI format, are associated with the first NDI field format, and
wherein the configuration information indicates that a second one or more DCI formats are associated with a second NDI field format of the one or more NDI field formats.

4. The UE of claim 1, wherein the first DCI communication is associated with a hybrid automatic repeat request (HARQ) process identifier, and
wherein other DCI communications associated with the HARQ process identifier are associated with the first DCI format or a second DCI format that is associated with the first NDI field format.

5. The UE of claim 1, wherein the first DCI communication is associated with a hybrid automatic repeat request (HARQ) process identifier, wherein the first DCI communication schedules a transport block, and
wherein other DCI communications, scheduling respective retransmissions of the transport block, are associated with the first DCI format or a second DCI format that is associated with the first NDI field format.

6. The UE of claim 1, wherein the first DCI communication is associated with a hybrid automatic repeat request (HARQ) process identifier, wherein the first DCI communication schedules a first transport block, and wherein the one or more processors are further configured to cause the UE to:
receive a second DCI communication, associated with the HARQ process identifier, scheduling a second transport block, wherein the second DCI communication is associated with a second NDI field format of the one or more NDI field formats.

7. The UE of claim 6, wherein the one or more processors are further configured to cause the UE to:
identify that the second DCI communication is scheduling the second transport block based on the second DCI communication being associated with the second NDI field format.

8. The UE of claim 1, wherein the first DCI communication is associated with a hybrid automatic repeat request (HARQ) process identifier, wherein the first DCI communication schedules a first transport block, and wherein the one or more processors are further configured to cause the UE to:
receive a second DCI communication, associated with the HARQ process identifier, scheduling a retransmission of the transport block or scheduling a second transport block, wherein the second DCI communication is associated with a second NDI field format of the one or more NDI field formats.

9. The UE of claim 8, wherein the first NDI field format is associated with a first NDI field size of a first quantity of bits, wherein the second NDI field format is associated with a second NDI field size of a second quantity of bits, and wherein the one or more processors are further configured to cause the UE to:
identify whether the second DCI communication schedules the retransmission of the transport block or schedules the second transport block based on a comparison of a first one or more bits included in a first NDI field of the first DCI communication to a second one or more bits included in a second NDI field of the second DCI communication.

10. The UE of claim 8, wherein the one or more processors are further configured to cause the UE to:
identify, after receiving the first DCI communication, a first NDI value associated with the HARQ process identifier based on a first one or more bits included in a first NDI field of the first DCI communication and a previous NDI value associated with the HARQ process identifier;
identify, after receiving the second DCI communication, a second NDI value associated with the HARQ process identifier based on a second one or more bits included in a second NDI field of the second DCI communication and the first NDI value; and
identify whether the second DCI communication schedules the retransmission of the transport block or schedules the second transport block based on a comparison of the first NDI value to the second NDI value.

11. The UE of claim 10, wherein the first NDI value and the second NDI value are a same value, and wherein the one or more processors, to identify whether the second DCI communication schedules the retransmission of the transport block or schedules the second transport block, are configured to cause the UE to:
identify that the second DCI communication schedules the retransmission of the transport block based on the first NDI value and the second NDI value being the same value.

12. The UE of claim 10, wherein the one or more processors, to cause the UE to identify whether the second DCI communication schedules the retransmission of the transport block or schedules the second transport block, are configured to cause the UE to:
identify that the second DCI communication schedules the second transport block based on the first NDI value and the second NDI value being different values.

13. The UE of claim 10, wherein the first NDI field format is associated with a first NDI field size and the second NDI field format is associated with a second NDI field size, and wherein the first NDI value and the second NDI value have a size that is based on a larger size among the first NDI field size and the second NDI field size.

14. The UE of claim 10, wherein the first NDI value and the previous NDI value have a size, wherein the first NDI field format is associated with the size, wherein the first NDI value is a value indicated by an NDI field included in the first DCI communication.

15. The UE of claim 10, wherein the first NDI value and the previous NDI value have a first size, wherein the first NDI field format is associated with a second size that is smaller than the first size, and wherein identifying the first NDI value comprises: identify the first NDI value based on a comparison of a third one or more bits included in the previous NDI value to a value indicated by an NDI field included in the first DCI communication.

16. A network node for wireless communication, comprising:
one or more memories; and
one or more processors, coupled to the one or more memories, configured to cause the network node to:
transmit configuration information indicating one or more new data indicator (NDI) field formats for respective downlink control information (DCI) formats; and
transmit a first DCI communication associated with a first DCI format in accordance with a first NDI field format, of the one or more NDI field formats, associated with the first DCI format.

17. The network node of claim 16, wherein each NDI field format, of the one or more NDI field formats, indicates a size of an NDI field associated with that NDI field format.

18. The network node of claim 16, wherein the one or more NDI field formats are configured for a component carrier.

19. The network node of claim 16, wherein the respective DCI formats include non-fallback DCI formats.

20. The network node of claim 16, wherein the configuration information indicates that a first one or more DCI formats associated with scheduling downlink transmissions are associated with different NDI field formats than a second one or more DCI formats that are associated with scheduling uplink transmissions.

21. The network node of claim 16, wherein the configuration information indicates that a first one or more DCI formats, including the first DCI format, are associated with the first NDI field format, and
wherein the configuration information indicates that a second one or more DCI formats are associated with a second NDI field format of the one or more NDI field formats.

22. The network node of claim 21, wherein the first NDI field format is associated with a first NDI field size and the second NDI field format is associated with a second NDI field size, wherein the first NDI field size is larger than the second NDI field size, and wherein the first one or more DCI formats include non-fallback DCI formats and the second one or more DCI formats include fallback DCI formats.

23. The network node of claim 16, wherein the first DCI communication is associated with a hybrid automatic repeat request (HARQ) process identifier, and wherein other DCI communications associated with the HARQ process identifier are associated with the first DCI format or a second DCI format that is associated with the first NDI field format.

24. The network node of claim 16, wherein the first DCI communication is associated with a hybrid automatic repeat request (HARQ) process identifier, wherein the first DCI communication schedules a transport block, and
wherein other DCI communications, scheduling respective retransmissions of the transport block, are associated with the first DCI format or a second DCI format that is associated with the first NDI field format.

25. The network node of claim 16, wherein the first DCI communication is associated with a hybrid automatic repeat request (HARQ) process identifier, wherein the first DCI communication schedules a first transport block, and wherein the one or more processors are further configured to cause the network node to:
transmit a second DCI communication, associated with the HARQ process identifier, scheduling a second transport block, wherein the second DCI communication is associated with a second NDI field format of the one or more NDI field formats.

26. The network node of claim 16, wherein the first DCI communication is associated with a hybrid automatic repeat request (HARQ) process identifier, wherein the first DCI communication schedules a first transport block, and wherein the one or more processors are further configured to cause the network node to:
transmit a second DCI communication, associated with the HARQ process identifier, scheduling a retransmission of the transport block or scheduling a second transport block, wherein the second DCI communication is associated with a second NDI field format of the one or more NDI field formats.

27. A method of wireless communication performed by a user equipment (UE), comprising:
obtaining configuration information indicating one or more new data indicator (NDI) field formats for respective downlink control information (DCI) formats; and
receiving a first DCI communication associated with a first DCI format associated with a first NDI field format, of the one or more NDI field formats, as indicated by the configuration information.

28. The method of claim 27, wherein each NDI field format, of the one or more NDI field formats, indicates a size of an NDI field associated with that NDI field format.

29. A method of wireless communication performed by a network node, comprising:
transmitting configuration information indicating one or more new data indicator (NDI) field formats for respective downlink control information (DCI) formats; and
transmitting a first DCI communication associated with a first DCI format in accordance with a first NDI field format, of the one or more NDI field formats, associated with the first DCI format.

30. The method of claim 29, wherein the one or more NDI field formats are configured for a component carrier.
